(19) United States
(12) Patent Application Publication
(10) Pub. No.: US 2004/0255179 A1
(43) Pub. Date: Dec. 16, 2004

(54) System and method for improving the efficiency, comfort, and/or reliability in operating systems, such as for example windows

(76) Inventor: Yaron Mayer, Jerusalem (IL)

Correspondence Address: YARON MAYER, 21 AHAD HAAM ST., JERUSALEM, 92151, IL

(21) Appl. No.: 10/775,027

(22) Filed: Feb. 8, 2004

Related U.S. Application Data
(60) Provisional application No. 60/464,171, filed on Apr. 14, 2003.

(30) Foreign Application Priority Data
Feb. 7, 2003 (IL) 154349
Sep. 29, 2003 (CA) 2,444,685

(51) Int. Cl. H02H 3/05

(52) U.S. Cl. 714/1

(57) ABSTRACT

Although MS Windows (in its various versions) is at present the most popular OS (Operating System) in personal computers, after years of consecutive improvements there are still various issues which need to be improved, which include for example issues of efficiency, comfort, and/or reliability. The present invention tries to solve the above problems in new ways that include considerable improvements over the prior art. Preferably the system allows for example a “Reset” function, which means that preferably an Image of the state of the OS (including all loaded software) is saved immediately after a successful boot on the disk or other non-volatile memory and is preferably automatically updated when new drivers and/or software that changes the state after a boot is added, so that if the system gets stuck it can be instantly restarted as if it has been rebooted. Other features include for example solving the problem that the focus can be grabbed while the user is typing something, allowing the user to easily define or increase or decrease the priority of various processes or open windows, a powerful undo feature that can include preferably even any changes to the hard disk, improved undo features in word processing, improved file comparison features, being able for example to track changes retroactively, improved backup features, and many additional improvements.

This Patent application claims priority from Israeli application 154349 of Feb. 7, 2003, hereby incorporated by reference in its entirety, and also claims benefit and priority from the following US provisional application, hereby incorporated by reference in its entirety: 60/464,171 of Apr. 14, 2003.

This patent application also claims priority from Canadian application 2,444,685 of Sep. 9, 2003 and from Canadian application (number not known yet) of Jan. 6, 2004, hereby incorporated by reference in their entireties.

### BACKGROUND OF THE INVENTION

1. Field of the Invention

The present invention relates to operating systems, and more specifically to a System and method for improving the efficiency, comfort, and/or reliability in Operating Systems, such as for example Microsoft Windows. This can include for example also things that are related for example to Word processing (since for example in Microsoft Windows, Word behaves like an integral part of the system) and things that are related to the user's Internet surfing experience (This is important since for example in Microsoft Windows, Internet Explorer is practically an integral part of the OS). The invention deals also with some preferable improvements in the performance of the hard disk.

2. Background

Although MS Windows (in its various versions) is at present the most popular OS (Operating System) in personal computers, after years of consecutive improvements there are still various issues which need to be improved, which include for example issues of efficiency, comfort, and/or reliability. In the area of efficiency, one of the things that still need improvement is the time it takes the system to boot. For example if windows 98 gets stuck, the user might have to re-boot the system, a process which can take up to a few minutes, especially if there are many programs in the start-up folder and/or if the system starts to scan the disks (If the user does not interrupt the disk scan). Although Windows Me and XP for example include a Hibernate function, it does not help much if the system gets stuck, since Hibernate is mainly useful if the user requests the system on his own initiative to “go to sleep” for fast awakening afterwards. This is accomplished typically by saving an Image of the current state of the computer's memory on the disk when the user issues the “Hibernate” command, and reloading it quickly when the user requests “wake-up”. U.S. Patent application 20020078338 filed on Dec. 15, 2000 by IBM, describes an improvement in which the Image is saved automatically immediately after the normal boot sequence has finished, so that, during the next boot, the boot can be automatically set to much faster if there is an Image of the state of the computer and the OS at the end of the last boot. However, this still does not solve the problem completely, since for example if Scandisk is needed, it can still take considerable time, such as for example a number of minutes or even more, and also for example some peripheral devices checks and/or initializations might still be needed and can take for example even up to a minute even during the “instant” boot. The IBM patent does not even mention the problem of the peripheral devices or drivers. Issues of convenience can include for example the fact that various things happen automatically in Windows without asking the user's permission—for example one thing that can aggravate users is the ability of other programs to suddenly snatch the focus from the current Window. If this happens for example while the user is trying to type something, it can be very irritating, especially if it's for example some pop-up commercial advertisement in a browser window while the user is surfing the web and is trying for example to type some data in a form input line or in the URL line. Another convenience issue is for example the problem that when installing a new version of Windows over an existing system, typically the user has a choice of either overwriting the current system, in which case the desktop will remain the same as much as possible (but the user will have to give up the option of still booting the old system), or to install it in a new partition, in which case the user typically has to install almost everything again from scratch. An example of a reliability issue is the fact that making errors, such as for example launching a program which contains a virus or a malicious code, or installing a program which accidentally causes damage for example to the Windows registry or to various directories, can be very difficult to correct. Although, for example, starting from windows ME, there is an option to undo the last installation, it is typically limited to only very specific types of changes in the system, such as for example changes in the registry, but cannot undo other changes, such as for example ruining other directories or files. Clearly it would be desirable to have improved versions of Windows or of similar Operating Systems, where such problems are solved.

### SUMMARY OF THE INVENTION

The present invention tries to solve the above problems in new ways that include considerable improvements over the prior art. Regarding the boot problem, preferably the system allows a “Reset” function which means that preferably an Image of the state of the OS (including all loaded software) is saved immediately after a successful boot on the disk and/or on other non-volatile memory and is preferably automatically updated when new drivers and/or software that changes the state after a boot is added. Another possible variation is that more than one Image can be saved, so that for example if something goes wrong after updating the Image, the system can preferably go back for example to the previous Image. Whenever the system gets stuck (and/or for example if the user simply wants to clear the computer's memory and go back to a state like after a normal boot), preferably the user is able for example to press some special button or some key or keys on the keyboard in a way that causes the computer's memory to instantly Reset from the saved Image, without a need to go through a boot sequence at all. The special button or key is preferably sensed either by hardware or by some process which preferably runs below the Operating system and thus in not affected even when the system becomes stuck. In addition, preferably any cut & paste buffers are automatically saved also on the disk and/or other non-volatile memory, so that they can be immediately available on the next boot or after the next Reset. Similarly, preferably any currently edited files or windows are preferably automatically saved on the disk and/or on other non-volatile memory preferably after sufficient minimal changes have accumulated (such as for example after at least 10 new characters, or any other convenient number, have been added or changed) or every short while (for example every 30 seconds), so that they can be immediately available on the next boot or after the next Reset. Preferably, during or after a fast-boot or a Reset that uses the memory Image (and/or even during or after a normal boot), if the FAT of the disks needs to be checked, preferably it is done in the background and without significantly slowing down the disk or the CPU, after the user can already start working, since waiting for scandisk to finish can take several minutes and can be very aggravating to most users. Preferably the system runs a minimal scandisk in advance at most only on the area where the image itself is stored or does that only if there is for example some CRC problem when trying to get the image, since only that area might have to be scanned before the boot or Reset if there is a problem. Another possible variation is that the Scandisk (or similar software) is backed up by hardware, for example in a way similar to the hardware that supports automatic disk rollback, described below. Preferably this is done by using hard-disks or other non-volatile memory wherein a special area or areas is dedicated for FAT information, and preferably independent head or heads or other access means are used for read and write in those areas. This has the further advantage that any reading or writing of files can become faster even if they are fragmented, since less movements of the heads are needed to access the FAT area each time some jump is needed (Of course the FAT can be also for example loaded into RAM or into cache memory for reading, but due to safety reasons changes to the FAT have to written to the hard-disk or other non-volatile media as soon as possible, and that is why these improvements are very important). Since each disk can have more than one partition, preferably the FAT areas of all partitions are kept in the same special area or areas. Preferably these areas are also guarded better in terms of security, so that for example any write-access to them is monitored more closely. Of course the Image and/or any other saved data can be kept also, in addition or instead, on any non-volatile type of memory, such as for example MRAM (Magnetic RAM), which will become available in a few years, 3d Nano-RAM chips, etc. In such cases, instead of separate or independent heads, for example separate or independent access channels or processors can be used. Of course, various combinations of the above and other variations can also be used.

Regarding the focus-grabbing problem, preferably when the user is in the middle of typing something, preferably the focus cannot be automatically snatched away by another program, so that for example the change of focus can occur only after the user has stopped typing for a certain minimal period, such as for example a few seconds or more. Another possible variation is that other programs can snatch the focus only in case of emergency, such as for example an event that is intercepted by the computer's security system, the firewall, or the OS. Preferably this is done by allowing this only to the OS and/or the security system of the computer and/or for example the firewall, and/or any other software which has been given explicit permission by the user to have such rights. Another possible variation is that programs are not allowed to snatch away the focus while the user is in the middle of typing something, as above, but for example in case of emergency, for example instead of snatching away the focus, important messages can be displayed for example by flashing a message on some part of the screen and/or by any other conspicuous visual means and/for example or by audible sound (for example a spoken vocal message), so that the user's attention can be immediately grabbed, without automatically disturbing his typing efforts. Another possible variation is that if the focus is snatched while the user was typing, preferably his keystrokes continue to be kept for example in a special buffer, so that when the user notices that the focus has changed and goes back to the original window where he was typing, the keys that he typed while the focus has changed are again available. This can be done for example by a special process (for example part of the OS, or some dedicated service) that keeps a copy of the most recent keystrokes and can replay them even if the keystrokes were supposedly wasted in another process that popped up during the typing. Of course, various combinations of the above and other variations can also be used.

Another possible variation that is also related to the focus issue, is that for example clicking with the mouse on any part of the desktop (or for example pressing some key or keys on the keyboard) will immediately bring the desktop fully into the foreground like clicking on any other windows, so that there is no need to click for example on the special icon in the taskbar to do that, as exists today for example in Windows. In the prior art clicking on the desktop does not cause other windows that cover parts of it to move down to the task bar, eventhough it can change the focus, so the user has to click on a special icon if he wants to get a clear view of the desktop. Preferably this option is made available to the user in addition to and not instead of the icon that brings the desktop to the foreground, since sometimes there is no piece of the desktop available for clicking on it, but on the other hand, if part of the desktop is in view, it is much easier to click on it than to have to go down to the specific location of the small icon, and also in the current prior art situation it can be quite frustrating that clicking on a visible part of the desktop does not automatically bring the desktop to the foreground, unlike any other windows where clicking on any part of it does bring it automatically to the foreground.

Another possible variation that is also related to the focus issue is to add for example a feature that allows the user more easily to define or increase or decrease the priority of various processes or open windows, since for example many times the user wishes some program to continue working on something lengthy in the background while he is doing other things, but many times the OS automatically assumes that if the user diverted the focus to something else, the processes that are in the background (i.e. not in focus) can be given much lower priority and so left to work much slower, so that the user finds that very little progress has been made when he goes back for example to a process that could have been finished in a few minutes if it was in the foreground or given higher priority (This can happen for example especially with programs that are running in a DOS window for example in Windows 98). Preferably the user can easily define the desired priority level for such background processes, for example in terms of percentages, and/or in terms of increasing or decreasing some default values for example in a few discrete steps, and/or for example in terms of more general definitions such as for example “Very high, high, medium, low, very low”, etc. Although typically a programmer can define the level of priority for a process, the user for example in Windows 98 does not have such a choice except in a few programs in which the programmers chose to explicitly give the user such an option, and also the user does not typically know which priority was set by the programmer. So preferably the OS also indicates to the user clearly, for example by colors (for example brighter colors for higher priority process) and/or by numeric and/or textual values and/or by appropriate icons, the level of priority that has been given to each process, for example by indicating it near or on each square in the for example bottom taskbar that shows active processes, and/or indicating it for example at the top line of the window of each process. For example on the square in the taskbar it can be more preferable to indicate this by a color, since there is little space, and for example on the top line of a window it is easier to indicate this for example by a combination of color and/or for example more exact numeric indication. Therefore, the default first priority shown to the user can be for example a default priority automatically set by the OS or the priority set by the programmer, or for example the priority set by the user the last time the program was run. Preferably the user can easily change the priority for example by clicking on the place where the priority is indicated at or near the taskbar and/or on the window of the process (for example at the top line), so that for example the clicking opens a preferably small windows where the user can choose the priority or for example a lever is shown which the user can pull up or down. Preferably the OS remembers the priorities given by the user to various processes and uses these defaults or at least takes them into consideration for assigning automatically the priorities the next time the user does similar things or activates the same processes, unless the user again changes the priorities. Although Windows XP for example allows the user to choose between more or less priority to background processes in general, this does not allow the user to choose it for individual processes, and the user has to go into the control panel to reach the place where it can be changed. On the other hand, in Windows XP the user may choose among a few priority levels for each process by pressing Control-Alt-Del and entering the task manager, however this does not show automatically the priority for each process, and the user has to click on each process in the task manager separately and choose from a menu in order to view or change its priority. On the other hand the user may for example use the Process Viewer (Pviewer.exe), a tool on the Windows NT Resource Kit 4.0 CD, to change also the priority of individual processes, but this requires entering a special window where all the processes are listed. Similarly for example a shareware called Priority Master (version 3.2) includes even more options, and can indicate for example the priority of a process if the user hovers the mouse for about a second above an item in the bottom task bar, and also shows this indeed on the title line of an open window. However, the above suggested improvement of constantly displaying the priority near each square in the task bar is more convenient and more efficient. Another possible improvement is that the taskbar can show automatically for example also how much percent of CPU is being used on average by each open process. Although windows XP for example allows the user to view CPU usage of various processes in a special window, preferably the user can also see this directly on the task bar without having to go through special menus for that. Another possible variation is that the priority of background and/or foreground processes is automatically dynamically increased according to the type of the work the user is doing in the foreground window, so that if the user is for example typing on Word or surfing with Netscape, more CPU resources can be automatically allocated to the background programs. This is especially important for example when DOS programs are involved since in the prior art usually if they are in the background for example in Windows 98, they can remain with very low priority even if the user is just typing or even if the computer is not really doing anything, whereas much more CPU could have been allocated to them. Of course, various combinations of the above and other variations can also be used.

Regarding installation of a new operating system in a new directory or partition, preferably during the installation the new system preferably automatically copies the desktop configuration and links from the old system into the desktop of the new system. Since some installed components will not work the same between two different versions of Windows (such as for example when running installed components of windows 98 on windows XP), preferably the system automatically checks which programs can work automatically without problems also in the new system (for example applications that don't have to access the registry, etc.), and preferably for example indicates to the user which applications might need some adjustment and/or tries automatically to solve this problem for those applications too. There are a number of possible preferable solutions for this, of which preferably at least one is used:

1. During installation of the new system, preferably the system tries to automatically convert components that are different between the two systems to work on the new system, for example by automatically converting system calls, memory structures (if needed), etc.

2. During installation of the new system, preferably the system tries to locate the original files which were used for the installation and then tries to reinstall automatically the correct drivers or components that are needed for the new system. For this, preferably each Windows system keeps information (for example in the registry and/or in one or more of the directories where the installed program or component or drivers resides) about the path and name of the original file from which it was installed, so that the installation can be automatically repeated into the new system, this time with the components that are needed for the new system.

3. If the system does not succeed in converting the relevant links or components to work on the new system or for example the original installation program is limited only to the old system (for example Windows 98) and does not contain for example drivers for the new system (for example Windows XP), then preferably the system marks the relevant links on the new desktop as non-operational (for example by giving them dim gray color) and encourages the user to look for other versions of those programs that are fitted to work on the new system. Another possible variation is that in such cases the system allows the link to activate the version that runs under the old system (or for example creates another copy of it) and uses emulation of the old system when needed in order to let it run. Another possible variation is that the system can automatically try to locate on the Internet any needed variations or drivers that will work on the new OS and for example recommends them to the user and/or for example can download them automatically from certified sources (preferably of course only after user authorization for each downloaded file). (This is relevant mainly for example for shareware programs).

4. Preferably a new protocol for installing programs is implemented so that each installation of new software preferably installs both the appropriate drivers or components (for example Windows 98 drivers on a windows 98 system) and one or more sets of alternate drivers or components (for example for Windows NT/XP or other Operating Systems), and preferably each time the program is loaded into memory the appropriate set of drivers or components is automatically chosen by the OS. However, since in some programs part of the installation requires for example updating registries and/or installing various components in system directories, preferably those parts of the installation are suspended and are executed automatically for example the first time that the new OS is activated for the first time after installing it.

Of course, various combinations of the above and other variations can also be used.

Regarding the undo problem, preferably any changes in the entire hard disk or other types of preferably fast mass storage non-volatile memory after or during the installation of new software, are completely undo-able at least for a certain time period. This is more comprehensive than the current “undo” feature that Microsoft for example offers after installing new software, since the current features only allow restoring the registry and system files, and even that not always completely, whereas any other changes to directories or files cannot be undone. A more extreme variation is that for example any changes at all that happen on the hard disk or other non-volatile memory (and possibly even on other connected media) at any time are completely undo-able at least for a certain time period, in a way similar for example to the undo feature in a single Word document. The above Undo features are preferably accomplished by keeping one or more rollback log, preferably backed up by appropriate hardware on the disk—as explained below in the reference to FIG. 2. Other possible improvements in word processing programs such as for example Microsoft Word can include preferably at least one of the following:

1. Adding to word processors such as for example Word, for example a smart file-compare features that can show exactly the textual differences between two or more files while disregarding irrelevant data such as line breaks, fonts, etc. In the prior art this can be done for example by a text file compare program after saving the word file as text files with line breaks, but then the comparison might show many irrelevant changes for each paragraph because of changes in line breaks for example if even one word was changed near the beginning of the paragraph. Another possible variation is to allow the program to merge for example two files into a single file with highlighted changes just as if one of the files was created out of the other while keeping the “highlight changes” option to On. This is very useful for example for checking changes between a current version of a file and any of the previous versions retroactively even if no change tracking was used during the time that the changes were made. In order to accomplish this preferably the changes are checked in a way similar to the non-merging file comparison, except that the results are displayed in the form of the merged file. Another possible variation is that for example cut & paste of one file over another file (and/or in fact cut & paste s section, such as for example a few words or a few lines or one or more paragraphs, over another section) when “highlight changes” is set to ON automatically generates the highlighted changes between the two sections as if they were made by actually changing one to the other, instead of the current prior art in which the results of such cut & paste are that the old text area is simply marked as deleted by strikeover and the new text is simply marked as added (this is preferably accomplished, again, by simple comparison between the original text and the pasted text, and marking the differences by the conventions of highlighted changes, as if the changes were made manually). Although Microsoft Word currently allows an option of file comparison, which marks the changes between the two files as if the “track changes” was set to On between the old file and the new file, as explained above comparing sections by cut and paste does not work (the previous text is simply marked as deleted and the pasted text is marked as new, instead of making a comparison), and even the comparison of two files is not sufficiently reliable and has at least the following problems:

a. If at least one of the two compared files already contains marked changes, Word warns you that it may not be able to show all the changes, and there is no differentiation between previous marked changes and the changes that are indicated by the comparison itself. In order to solve this preferably in such cases a different indication is used between the old changes and the new changes generated by the comparison, for example by using additional colors, and/or using for example different special icons and/or marks near the old changes and/or near the new changes, and/or using for example different special squares and/or other frames around the old and/or the new changes, and/or using for example special fonts and/or other font characteristics, etc. However, using different colors could be problematic since different colors are already used for indicating who made each set of changes, so this might be confusing, and in addition, if such a file (that resulted from a comparison) is then again compared with another file, more and more colors might be needed. A more preferred variation is that for example in each stage of the comparison the old changes are automatically marked for example by more faded or less lit colors (but preferably keeping the original colors), and if comparison steps continue then preferably at the next step preferably all previous changes now become faded, and the new comparison changes are marked with brighter colors. However, these are just examples and any type different marking can be used.

b. The file comparison is not always reliable and may get sections confused, so that for example when comparing two patent files, the comparison can confuse for example between a claims section and a specification section, thus marking entire areas as deleted and added instead of properly comparing them. In order to prevent this, preferably the system uses preferably various heuristics in order to extract from the document important information about its structure, so that for example a section that appears after a clear headline (which is typically for example on a separate line and is typically emphasized for example by boldface and/or by underline and/or sometimes for example by capital letters) is preferably automatically recognized as a different section of the documents, and this way for example a section that appears after the headline CLAIMS will not be confused with a specification section. In addition, the system can use for example other cues about each section, since for example the claims section is clearly characterized by short paragraphs that each start with a consecutive number, which is unlike any other part in the document. Such cues and/or heuristics are preferably used in a fuzzy manner, so that they are considered as part of the evidence but not as absolute guidelines, so that for example if there is more evidence that indicates otherwise, such cues can preferably also be ignored. For example a thorough academic article from 1988 about file comparisons at http://citeseer.nj.nec.com/cache/papers/cs/6985/http:zSzzSzwww.ime. usp.brzSz˜iszSzpapirzSzsctp.pdf/simon88sequence.pdf shows that the file comparison problem is theoretically and practically not completely solved yet, but this article deals mainly with various methods of increasing the speed of such algorithms (which is far less critical today, now that computers are thousands of times faster than 15 years ago), and much less with how to improve the reliability of such algorithms. U.S. Pat. No. 6,526,410, issued on Feb. 25 2003 to the Hitachi company, shows how to improve such algorithms in explicitly structured documents, such as for example XML documents, by making the comparison first between the XML structures, and then comparing the text only between structures that are determined to be within the corresponding sub-structure, and typically working with a table of explicit comparison rules. However their solution does not solve the problem for example for Word documents, which are the most common type of documents for example in legal documents such as for example contracts and for example patent applications, where file comparison can be very important. Therefore, the above suggested solution is much more general since it can work for example also with word processing documents, such as for example Word documents, where there is no explicit hard-definition structure, but smart heuristics can easily use relevant cues to identify actual sections, and in addition the above solution is more flexible since the identified sections preferably don't become absolutely binding, so that for example if other criteria (such as for example the percent of the common sequences found) indicate that it is better to ignore one or more apparent section indicators, this is preferably done. In addition, preferably the same principles are used and applied recursively when needed. Another possible variation is that for example if the user sees that a certain part of the documents (or more than one part) has not been properly merged (for example the end of the specification together with the claims), then the user can preferably for example mark, for example with the mouse, the problematic section or sections, and then tell the system to try again to merge more properly the problematic section or sections.

c. Only 2 files can be compared at each step. So instead, preferably the system allows to compare also more than two files in each step, and so in the merged file of for example 3 files, changes that come from different files are preferably marked in different colors (for example in a way similar to marking changes that were added by different people in different colors), or marked differentially by other methods, for example such as those mentioned in clause ‘a’ above.

2. Preferably the word processing program behaves consistently with cut & paste where Internet pages are involved, so that for example images are kept properly as an internal part of the document (preferably including also any internet links that the images are pointing to), just as if they were included out of a file for example. For example the way Microsoft Word currently behaves is that if you save a remote Internet page by cut & paste (such as for example http://news.google.com) then the images don't show up at all. On the other hand, if you first save the page locally and then use cut & paste then the images do show up, however they are linked to the local directory where the images were saved, so if the user for example later sends the same Word file to someone else then the images are again missing when that someone else opens the file. (This same problem happens also if the page that was saved locally is properly opened by Word as a local web page and for example is then saved as a Word document). This is inconsistent with the behavior of other images, which become an integral part of the file. This is preferably solved as follows: If the links are to local images then preferably they are automatically inserted into the document file itself, and if they are based on links to the actual Internet then preferably they are also included internally in the document and/or are saved as links (preferably the user is asked which these options he prefers).

3. Preferably the word processing program (or other programs that deal with opening files, such as for example other Office programs) remembers automatically for example in the “Open file” dialogue box and/or in the “Save” dialogue box if the user typed last time a filename (or path) in English or in another language (for example Hebrew) and preferably leaves this as the default for the next time. This is very important since it can be very aggravating if the program for example insists each time to start the dialogue box in Hebrew even though the user wants each time to type a name in English. Preferably this default is remembered of course also after closing and re-opening the word processor (for example by saving it automatically in some preferably small configuration file).

4. Preferably the user can use for example \hat{ }z (Control-z) (or other similar commands) to undo the last changes even after closing and reopening a file, unlike the prior art, in which this can only be done as long as the file remains open. This is preferably done either by saving the undo data in the file itself, or (more preferably) by saving it preferably in another local file, so that the original file preferably only contains a link to the associated local undo file. This has the advantage that when sending for example the file to someone else the previous versions and last changes are not transmitted together with that file to the other person, and yet the original user has flexibility to use the undo even after the file was already closed, as explained above.

5. Preferably the word processor program allows the user also options of searching and/or substituting for example based on style and/or shape and/or size instead of just character strings, so that for example the user can request to find the next underlined word (or words), or for example the next words that are in italics or for example request to automatically convert all the words that are in italics to underline or vice versa, or for example to automatically convert all fonts of size 13 to size 14 without affecting other font sizes, or for example to increase automatically all the font sizes by a certain additive or multiplicatory factor (so that for example each font size will increase by 1 pixel), etc.

6. In the prior art Microsoft Word, deleting the “Enter” between two paragraphs can cause for example the first paragraph to change automatically its font (for example become bigger or smaller or a different font or in a different style) for example according to some qualities of the empty line that was deleted between the paragraphs or some other reason. Since obviously the user does not intent to create such changes by merely deleting an empty line between two paragraphs, preferably no such changes are created. Preferably fonts and/or style are automatically changed for example only in the 2^{nd} paragraphs after connecting it with the 1^{st} paragraph (for example to become like in the first paragraph), and even that is preferably not done automatically but only if the user allows this by default or requests this specifically for example by pressing some key or some button.

7. Another problem with word processors such as for example Word, is that URL links (typically Internet links) (for example http://www.opnix.com/products_services/orbit1000/Middle_Mile_Mayhem.p df) are not treated properly when paragraphs are automatically aligned, so that for example a URL link that is too long can jump to the next line and cause the words in the previous line to become with too many spaces between them (as it happens for example with the above exemplary link), and if the user manually fixes this for example by breaking the URL for example at the position of one of the slashes, this will cause the link not to work properly, and also, if the paragraph is then changed again, the broken part of the link might come back to the previous line, thus causing the link to appear as if there is a space between the two parts. On the other hand, if the link is too long to fit even an independent line, it is currently broken by Word at the last character that fits the line (as happens in the above exemplary link), instead of breaking it more smartly, preferably according to the closest slash. So preferably this is improved, so that links are preferably automatically and dynamically broken and restored between the lines as the paragraph changes, preferably according to slashes (and/or for example sometimes underlines and/or dots and/or other special characters), and preferably when the user presses the link, it is treated as one consecutive link regardless of this automatically changing break between the lines

8. Another problem is that in large files if the user wants to mark large areas with the mouse (for example from a certain point till the end of the file), he must continue to hold the mouse pointer near the bottom of the page with the mouse key pressed, which can be quite annoying. So preferably for example while the mouse key is still pressed, the user can for example use other location commands, such as for example Control-PageDown or Control-End or search commands, and then preferably the entire area till the next location becomes marked, instead of having to wait for the page to scroll.

9. Another important improvement is that preferably the user can for example choose a specific font color and/or for example specific font attribute (for example underline) which preferably is kept automatically until changed again, so that this text preferably appears wherever the user adds it to previous text, regardless of the color or other attributes of the section of the previous text in which the new text in inserted. This is very convenient for example for keeping track of additions (for example when the user does not want to activate the automatic track changes), or for example for adding comments for example in another color. This is in contrast to the prior art, where for example in Word such options must be chosen again in each section, otherwise when the user starts to add text at a different place it automatically assumes the color and attributes of the surrounding text.

10. Another improvement is that preferably the word processor can allow the user to define page numbering that starts from a certain value other than 1, for example since page 50 (or any other desired number) since for example sometimes the user might want to print pages that will be attached after other already printed pages as if they are part of the same file. (This can be defined for example by letting the user use a formula, so that for example if the current page number is marked for example in Word as “#”, the user can preferably specify for example “#+49”, so the page numbering will start for example from 50 instead of 1).

11. Another problem is that for example Word sometimes decides to move paragraphs to the next page without any apparent reason, thus leaving sometimes a large empty space in the previous pages. So preferably the user can for example click in any such case for example on the empty space or on the moved paragraph and/or for example enter a command that tells the word processor that the user does not want such empty spaces, and/or for example the user can activate a command that automatically fixes all such empty spaces globally.

Of course, like other features of this invention, these features can be used also independently of any other features of this invention.

Additional improvements in the OS preferably include also at least one of the following:

1. Preferably the OS allows the user to define at least one User which the system (such as for example Windows NT or XP) will enter by default and without a password if the user does not request to enter a particular User after a certain time (for example 50 seconds) after the system reaches the menu that's asks to choose a User. This has the advantage that for example after a temporary power failure the system can automatically resume the original User. Preferably this is accompanied by the ability to define for example a sequence of actions to be taken upon entering this User by default, such as for example connecting with the Internet and activating a server and/or whatever other program or programs need to be resumed after a power failure. This is somewhat similar to programs in the startup menu, except that this feature is preferably more powerful, so that it enables for example to define also various sequences of actions or for example to carry on automatically certain activities only if the User was entered automatically by default. Another possible variation is that if the system enters the default User without password, preferably it enters a limited mode where for example it takes no commands from the keyboard or mouse and/or has other limitations, for example until the user for example comes back and enters some password. For example the system can enter immediately the state that it would be in if a screen saver was activated and a password is needed to resume operation with the keyboard or mouse.

2. Preferably if the user uses for example write-once CD's (and/or for example DVDs) for backup and uses direct writing software, such as for example DirectCD, if the user copies the same file more than once onto the same CD (to the same directory), then preferably the backup software can automatically rename the old files for example with some automatically sequenced extension, so that the user can automatically keep and track also older versions this way. This is quite useful for version tracking and is better than simply overwriting the file, since in such CDs the old data cannot really be overwritten anyway. Of course, preferably the user has an option of turning this feature on or off, and/or for example can activate it retroactively for example for write-one CD's or DVD's in which it has not been used (in this case preferably the system automatically reconstructs the version sequencing according to the time and date each “deleted” previous version was saved). Another possible variation is to apply such automatic sequencing automatically for example also to other drives and/or directories that the user defines as back-up drives or directories and/or to other types of backup devices. Another possible variation is to enable by default (or for example to allow the user to request it) automatic backup of important files to the default backup directory and/or drive and/or device, so that for example each doc file (or for example program source file, or other for example office type of file) that has been created or changed and has not been updated for more than a certain time period (for example 1 day or a few hours), and/or for example after a certain threshold amount of change even if less time has elapsed, is automatically backed-up on the default back-up media, and/or for example browser bookmark files are back-up like this, etc. (The important types of files are preferably defined automatically by default and/or user-defined). This can be a great help for example for users who forget to make backups. After the media becomes full and/or for example shortly before that the system can for example report this to the user and prompt him/her for example to insert a new blank writeable CD (or other media), etc. (In case of the bookmarks file for example, if for some reason the latest version has crashed or was damaged in anyway, preferably the system can automatically reconstruct the latest version for example by taking the last backed-up version and adding to it preferably automatically all the links that were visited from that time onwards, for example according to the browser's recent history list).

3. Preferably the OS allows the user to access at least one CD-ROM drive even when the OS is started for example in “safe mode”, otherwise it can be very frustrating when the user might not be able to fix various things for example because he cannot fix anything from the installation CD while in safe mode. In addition, if for example the OS becomes unstable or cannot complete a boot for example because of a problem with some driver, preferably the system is able to automatically remove and/or ignore and/or report to the user the driver that is causing the problem. Even if the problem for example crashed the computer completely so that the OS could not report anything, preferably during each boot the system for example keeps a log of all successful steps in the boot, and so even if a certain step causes a crash so that the system can't even report the problem, preferably in the next boot the system knows by the incomplete step in the log exactly where it crashed the last time and can preferably automatically complete the boot this time without the problematic step and preferably reports to the user exactly what the problem was and/or preferably automatically removes the problem and/or offers the user for example to chose among a few possible corrections to the problem so that the problem does not occur at all again after that.

4. Preferably the Windows OS allows executing files in DOS mode also by clicking on or near their name instead of having to type it. This is very important for example in Windows NT or XP, since, unlike for example Windows 98, the user has to type the whole name of the command instead of being able to type also instead only the 8 character DOS name of it. Since for example in Windows NT and XP the user can in DOS mode click on the mouse in order for example to mark a name for cut and paste, preferably the execute command is added for example to the menu of these available options. (Of course there are programs that can be used for example for automatic file completion, but this is another option that allows more flexibility and convenience to the user).

5. Preferably the OS itself and/or various relevant applications can display for certain activities approximately how much time it is going to take and/or for example the percent completed and/or the percent remaining—even if these are complex activities such as for example when scanning for viruses. Although many applications do give such information—these are typically application that deal with a single file or a pre-specified list of files, whereas for example virus scanning programs do not, which can be aggravating to users, since such activities can typically take for example anywhere between 5-20 minutes. So preferably the relevant applications and/or the OS can automatically calculate for example the number of files and/or their cumulative size (preferably of course only for the relevant types of files that are to be scanned), and thus for example the application and/or the OS can display to the user an estimate of time and/or percent done and/or percent remaining. Preferably this is made available for example also to the application's programmer, for example as an OS function that can return for example the total number of files of a certain type and/or extension and/or their cumulative sizes, for example on the entire computer or for example on a given drive or directory (preferably automatically including all of its sub-directories).

6. Preferably commands such as for example “copy” are extended so that multiple destinations can be used, so that for example copy “bet*.doc 1: n:” will copy all the relevant files to all the destination drives/directories.

7. Preferably various Undo commands are applied also to various memory related commands where they do not yet exist, so that for example if the user works with an Internet browser and presses a “clear form” button, preferably the user can undo it for example by pressing control-z or for example pressing for example some undo button for example on the browser.

Other improvements can be done for example in statistical packages, such as for example SPSS, so that for example when correlations (or other types of output) are displayed (for example on the screen and/or in printed form) for a large number of variables, preferably the user can for example instruct the system to automatically mark for him/her the most significant correlations, for example by automatically encircling them and/or for example using some special icons and/or fonts and/or colors and/or other marks, and/or putting them for example in a different section. The criteria for which correlations are sufficiently significant can be for example some default criteria defined by the user and/or automatically by the system, such as for example only correlations above 0.2 (or other significant cutting point or points defined for example by the user and/or by the system), and/or for example only correlations where the significance is 0.005 or less (or other reasonable cutting points defined for example by the user and/or by the system), etc., or for example the cutting points automatically and/or by user definition can preferably change dynamically according to the results, so that for example they can be automatically determined according to the number of correlations (for example if there are much more correlations in the results than preferably the cutting points become more demanding), or for example the cutting point is in addition or instead based on relative percent, so that for example the top 5% best correlations (or any other desired percentage, definable for example by the user and/or automatically by the system) are automatically marked, and/or for example some combination is used, so that for example only the top x % correlations that are also beyond a certain absolute cutting point (for example of correlation values and/or of significance) are automatically marked. In addition, since some correlations can be much less meaningful than others—for example various Pearson Corr or other correlation commands can create automatically also correlations of variables with themselves, preferably these are marked differently and/or ignored, and/or taken into account differently so that they do not distort the statistics. Another possible variation is that the user can mark for example one or more sections of the correlations results (for example with the mouse) so that these automatic marking or statistics will be run only on parts of the results (since for example some of the correlations might be known by the user to be more or less meaningful than others). Preferably, apart from marking the most important and/or meaningful correlations, the system can, in addition or instead, also report various meta-statistics, such as for example what percent of the correlations are beyond certain cutpoints (for example according to the correlation value and/or the significance), and preferably this can be for example reported for example as a combination of such cut points and/or for example for each cut point or criterion separately, and the system can preferably also report for example what is the significance of these meta-results, i.e. for example what is the chance that for example in these specific results 12.7% of the correlations have significance for example below 0.01 (or any other value), preferably while taking into consideration issues such as for example the total number of correlations, the number of cases upon which they are based, and preferably automatically ignoring all the correlations of variables with themselves and preferably also for example any other correlations that the user marked as less meaningful and/or that the system can for example automatically determine as being less meaningful. (For example variables that are defined in an overlapping way, for example because they are based on computation involving other variables, will create correlations that may be interesting but should preferably not be confused with other statistics since part of their correlation is artificial, and there should be no problem for the system to automatically identify the problematic correlations for example according to the “compute” commands that were used). Preferably these statistics can of course relate also for example directly to the marked results, so that for example the system can report what number of results was marked out of what total, what percent it is, and/or what is the chance of having such a meta-results by chance, however these meta-statistics preferably show also additional values. Another possible variation is that the system can automatically and/or by user request generate also various graphs for visually displaying these meta-statistics. (Although it is possible in the prior art to run for example a cluster analysis or an Addtree or Extree analysis on a set of output correlations, this is a very specific analysis that takes as its input a matrix of correlations and uses them as distance data to derive an analysis of the way these variables are clustered as a group. In contrast, the above suggested meta-statistics can be much more general and much for flexible, and thus can deal for example also with correlations that are not in the form of a matrix of correlations of N×N variables, and preferably can analyze for example the value of the correlations themselves, as explained in the above examples, whereas for example cluster analysis or Addtree or Extree take the correlations as input without analyzing the value or significance or meaningfulness of the correlations themselves. In addition, for example analysis such as Cluster analysis, Addtree or Extree are not a substitute for looking also at the correlations themselves, and the above described markings and/or meta-statistics can help the user analyze or evaluate also the correlations themselves). Another possible variation is that the system can for example use more than one type of mark, so that for example 2 or more levels of significance are marked differently, for example more conspicuously and/or with different colors. Another possible variation is that the system can for example automatically sort the results for example according to their value and/or importance and/or significance, so that for example in the case of correlations, for example the highest correlations and/or the correlations with the highest significance values and/or some combination of the above are displayed first. (Preferably the user can request for example if to display the correlations normally or in a sorted way, and if so, sorted by which criteria or combinations of criteria, and/or the user can for example also request some combination, so that for example the results are displayed according to certain structures and the sorting is for example only within the structures). Another possible variation is that for example instead of marking correlations, for example only the relevant correlations (or other results) that fit the criteria (and/or would have been marked) are printed, thus saving paper and time. However in that case of course preferably this is accompanied by meta-statistics that refer also to the non-printed results. These automatic markings and/or meta-statistics can be applied for example for each statistical procedure or command separately or for example to the entire set of procedures or commands, for example on the same Run. Another possible variation is that the system can for example automatically correct the significance scores of the correlations, for example according to the Bonferroni correction formula, so that the significances themselves are already displayed corrected, however that is less desirable, since it means that the significance can change all the time depending on the number of tests in the same run (or set of runs), thus making it confusing and not consistent when someone wants to compare various results. Another problem for example with Pearson correlations is that 1 or more extreme values away from a main cluster of values can sometimes distort the correlation. This is preferably solved for example by allowing the user to request automatically running the tests also on preferably automatic randomly divided sub-samples, and preferably the number and/or size of the sub-samples is determined automatically by the user and/or by the system (for example according to the number of cases and/or according to the variance and/or according to other parameters). Another possible variation is that this test is run automatically by default (for example unless the user explicitly requests to suppress it) and preferably the correlations (or other statistics results) can also be for example marked differently and/or displayed in a different section if they are more stable across these sub-sample tests, and/or the results of these stability or strength tests can be for example displayed each near the corresponding correlation (for example as a number indicating the stability value). Although for example SPSS has recently added to their most recent version (Ver. 12) the ability to request tests on sub-samples (a new feature called Complex Samples which uses CSPLAN to define the sampling parameters), the CSPLAN design specification is used only by specific procedures that are defined within the Complex Samples Option, whereas according to the above suggested solution automatic analysis by random sampling is preferably automatically available and automatically activated for any statistical procedure, and as explained above, the results of this analysis this can preferably be used automatically for example to mark the most important results. So preferably either the sub-sampling is done randomly and automatically by the system by using preferably automatic defaults and/or automatic rules that are preferably used to decide the most desirable sampling strategies according to various parameters of the actual data, and/or for example the user can define in addition or instead more specific parameters, for example by the above CSPLAN procedure, but preferably these definitions can then be applied automatically for example to any of the normal statistical procedures that are used for that run, and this is preferably used also for marking the best results, as explained above (and/or is taken into account for example for the sorting, so that for example correlations are sorted both by their size and/or significance and by their stability and/or for example within a certain level of strength the results are internally sorted by stability). The automatic rules defined by the system can for example take into account the original sample size, and for example determine the size of sub-samples by the minimum desired absolute size of the sub-sample and/or by the minimum desired size in percentages, and/or for example by the number of correlations that are tested, etc. For example the best automatic choice might simply be to create just a division of 2, but for example create this multiple times (for example 10 times or any other desired number) with a different random cut and compare the results for stability across all random attempts. Preferably there is for example one most preferred default, and if the user is not satisfied with this he can for example choose from a few other suggested defaults or sets of rules, and if the user still does not like any of them he can add his own rules in addition or instead. Of course, a list of correlation results is just an example, and similar principles can be applied for example to other types of statistical results where multiples results are presented together. This is much more convenient than the prior art, where the user typically had to print the results and mark manually the most significant ones. Of course, various combinations of the above and other variations can also be used. Of course, like other features of this invention, these features can be used also independently of any other features of this invention.

In addition, preferably various statistical programs that allow backwards checking, such as for example the search engine of http://search.wallstreetcity.com/wsc2/prosearch.html are preferably improved to allow the user much more flexibility in defining the backwards checks. For example, the Wallstreetcity.com search engine allows the user to test various investment strategies retroactively up to one year, in order to see which performed best. However, the user is thus limited to only a very small test period, which can be very unreliable, since if for example during 2003 the market came up from a multi-year low, strategies that work best at such periods might for example work very differently in other periods. So instead of this, preferably the user is allowed to use the retroactive test on much longer periods (such as for example up to 10 years backwards), and in addition, preferably the user can for example divide it to one or more sub-periods and see the performance for example on each sub-period, and the user can preferably define for example the exact starting point and/or ending point of each period or sub-period. In addition, in the prior art search engine the user has no control on the way the tested strategy is applied retroactively—for example are the N stocks that most fit the test criteria simply bought at the beginning of the retroactive test period (for example 12 months ago) and just held for the entire period, or for example every month the stocks are replaced if there are other stocks that now fit the criteria better, etc. So this is preferably improved so that the user can define for example exactly on which times or after every what period the stocks are again updated according to the strategy (for example every week or every month (or other convenient period) and/or for example the stocks can be updated automatically (for example even once a day or even any time) when there are one or more stocks that become better according to the criteria beyond a certain minimal margin of difference. For example if there are 8 stocks that were chosen according to the strategy, anytime that one or more new stocks become for example 5% or 10% more (or any other convenient margin) better than at least one of the for example 10 or 20 original stocks (according to the chosen criteria), then the appropriate stock or stocks can be automatically switched for example anytime during the retroactive test simulation. Preferably all of these stock swappings take into account also at least minimal required commissions, so that the end result of the simulation preferably reflects correctly the performance that would have been made after having also paid the necessary commissions in order to apply the strategy (in addition, preferably the user can specify the commission level that most correctly reflects what he would have to pay in reality if he did these swappings). Another problem is that this prior art search engine allows the user to define the past performance of the stock (which is one of the possible criteria) only in terms of performance over a defined period (for example the last 3 years or the last 5 years), which thus unnecessarily limits the user. So this is preferably improved to allow the user to define in addition or instead for example criteria such as for example choose the 10 or 20 (or any other convenient number of) stocks that performed in a certain way from the last peak (and the peak itself can be for example specified specifically by the user as for example as an exact date or for example automatically found by the system). This is important, since if for example a NASDAQ stock was at its peak in April 2000, and was for example much lower in January 1999 and in January 2001, it might be much more informative to take as a criterion for choosing stock their performance since the last sufficiently large peak, or for example since the highest peak that existed over the chosen period (where the peak is automatically found for example in the last 3 years or 5 years or any other desired period) instead of taking as the criterion automatically the performance since the beginning of the specified period. Of course, various combinations of the above and other variations can also be used. Of course, like other features of this invention, these features can be used also independently of any other features of this invention. Other improvements can be done for example with Internet browsers and/or other programs that access the Internet, so that for example preferably the browser can request from the server also just a part of an Internet page, such as for example a certain line or for example the value near certain words or areas or fields in the page, etc. This can save a lot of time and traffic, since for example programs that want to update data from various pages and/or run for example various statistics with data from a large number of pages might need just a small part of the data in each page, and thus this can be much more efficient than having to request the whole page and then look for the desired data in it. Although there exists already a format called RSS, which allows getting only a specific area from a web page, this is an XML format that requires specific definitions in advance in the desired web page in order to enable this. On the other hand, according the above improvement, specific requests can preferably referred to web servers regarding any pages, so that for example the browser (and/or for example other programs that accesses the Internet) can request from the server for example just a certain line or lines or words or words in the page, for example defined by position (such as for example lines 20-22), and/or for example defined by content (such as for example, Bring me only lines that contain a certain search string), etc. This is very important since most web pages today are much less structured than XML pages. The server can provide this information for example by simple string search on the web page, and then sending to the browser just the relevant data instead of the desired page. This can be done for example by the server itself or for example by additional software that runs preferably together with the server, preferably on the same computer or at least on the same site or location. Another improvement in Internet browsers is that preferably the user can for example mark a group of links (for example in the history list and/or in the bookmarks list of the browser, and/or for example in any web page that contains links) (for example in a way similar to marking more than one object in a scroll list), so that after the user for example marks the desired group or groups of links, preferably pressing for example some button causes the browser to automatically open multiple windows so that preferably each window accesses automatically one of the marked links. This can save a lot of time and increase surfing efficiency. Of course, various combinations of the above and other variations can also be used. Of course, like other features of this invention, these features can be used also independently of any other features of this invention.

In addition, preferably when searching for example for MIDI files on the Internet preferably the search engines are improved to enable for example automatically choosing the best MIDI files, for example by displaying first the most popular files. For example, in the current prior art the MIDI search engine http://www.musicrobot.com/ (which is perhaps the best MIDI search engine) Enables users to find MIDI files according to song names and shows first a list of all the song names that contain the search string, so that if for example the user searches for the song “yesterday once more” but uses as search string the words “yesterday once”, the results are displayed for example as shown in FIG. 4 below. As can be seen, the results are ordered not by the most popular entry (i.e. the file name that appears on most sites) but by being closest to the search string. In this prior art search engine, if the user then chooses to click for example on the most popular file (entry 4), he/she then gets a second division—according to the file length of the files with the same name (in increasing order), so that for example the list od results shows that a file named yesterdayoncemore.mid (with the length of 8,430 bytes) is available from 4 URLs (for which the user is given the links), a file with the same name and length of 24,601 bytes is available from 7 URLs (for which the user is given the links), etc. However, in reality, the file that appears in most URLs is usually the best MIDI version of the desired song, so this means that the user has to manually look for the file size that is available from the largest number of links, and sometime there are a large number of results (especially for more popular songs) so this is cumbersome. So in order to improve this, preferably in the first stage, after choosing the set of results that are sufficiently close to the search string, preferably the search engine automatically sorts the song names by the most popular in descending order (and/or for example the similarity to the search string is also taken into account, however if the original set was chosen properly this should not be necessary since at least most of the results in the set should be relevant, and the most popular names will probably include the song that the user is actually looking for). Secondly, after choosing the desired file name, preferably the 2^{nd} stage is also sorted by the number of links available for each file size (instead of the sorting by the file size in the prior art engine), and so the user can preferably typically with just 2 clicks of the mouse reach immediately the desired MIDI file that has the best chance of being a good version of the desired song. (This is another improvement in Internet search technology as defined for example in the present inventor's Canadian patent applications 2,443,036 of Sept. 14, 2003 and 2,444,774 of Sept. 29, 2003). Such a search or meta-search engine can for example work on a server on the Internet and/or can for example be at least partially implemented on the user's computer, for example as part of the OS (so that for example at least some of the processing of the results is done on the user's computer). Of course, MIDI files are just an example and similar principles can be used also for other types of searches, such as for example in Shopping metasearch engines, so that for example if the user is looking for example for a combined Fax-Scanner-Printer, the system preferably helps him/her choose the specific manufacturer and model for example by sorting the models by descending order of popularity. Another possible variation is to take into account for example also some ranking factor of the sources, so that for example Online stores that are much bigger or more important can be given higher weight. Of course, various combinations of the above and other variations can also be used. Of course, like other features of this invention, these features can be used also independently of any other features of this invention.

Another problem is that for example in laptops typically the hard disk is significantly slower than in non-mobile computers, in order to save power and extend the number of hours until the batteries run out of power, which causes many programs to load considerably more slowly and to work slower when saving or reading files. However this creates the absurd situation that even though the laptop might be used most of the time on a desk, connected to the wall electricity outlet, than on the road, the disk still works at the low speed all the time. So this is preferably solved by using a variable-speed hard disk which can automatically work significantly faster when the laptop is connected to the network electricity. So preferably the computer and/or the OS and/or the disk itself can automatically increase or decrease the speed of the hard disk according to sensing if the computer is currently connected to the network electricity or is currently running on the batteries. In addition, preferably the user can also for example press some button or request the OS to increase temporarily the disk's speed to the fast mode even when not connected to the external electricity (for example if the user needs something done fast, and then preferably the disk for example automatically reverts back to the slow speed for example after 5 or 10 minutes or any other convenient time, and/or for example according to the amount of power left and/or the current processes running). However, there is a problem that if he disk's engine is optimized to work efficiently when the power is on, it might work considerably inefficiently when running on the batteries, and if it optimized to run at high efficiency when running on the batteries it will not run efficiently when running for example in double speed when connected to the wall, thus increasing even further the heat dispersion problem in the laptop. In order to solve this, preferably the disk has at least two sets of engines or at least two sets of coils, which are used for example at different combinations in order to work in the low speed or in the fast speed. In addition, preferably the disk's DSP automatically starts working for example at higher MHz when the wall power is sensed. Another possible variation is using for example a disk with more heads on the same arm (which is typically moved in rotational movement part of a circle from the side, in a way similar to a phonograph's needle, typically by a voice coil), so that for example less movement is sufficient to cover the entire range. Although this means also having to move more mass, the arm is typically much more massive then its tip with the head, so adding another head that points for example sideways, as shown in FIG. 5a below, will not change much. Another possible variation is adding also for example additional heads, so that for example there are more heads at the length of the arm, however that could create a linearity problem. Other possible improvements that should enable faster disks with very little energy increase or even a reduction in energy consumption are shown in FIG. 5b-c. Another possible variation is to use for example instead of moving heads some elongated multi-head structure which does not have to move at all, so that preferably the point of reading is chosen electronically, for example by varying the position of some crossing point electronically. (Such a solution of course could make also normal hard disks work considerably faster). Another possible variation is to use even more than two speeds or modes. Another possible variation is that for example the user can choose in advance when buying the laptop if he prefers to get the laptop with a faster speed hard disk (for example a double-speed hard disk that will cause the battery power to run out for example after 2 hours), or a slow speed typical laptop hard disk which is for example twice slower but allows the battery with average usage to last for example for 3 hours). The heat dissipation problem with the faster disk is preferably solved for example by activating automatically for example an additional fan when the disk works at the higher speed, and/or adding for example additional heat conductors between the internals of the laptop to its outer shell. Of course, various combinations of the above and other variations can also be used. Of course, like other features of this invention, these features can be used also independently of any other features of this invention.

Another issue that has to do with the reliability issue is the fact that when people use Windows for example from an Internet Cafe, many times they forget to close down open connections and/or at least they leave behind traces such as for example various cookie files, temporary files, history logs, etc. There have already been cases that users who subsequently used the same computer misused this for example to send a false suicide note or to send a false kidnapping message, etc. Although some web based email sites, such as for example Hotmail and Yahoo, allow the user to mark when he/she is using a public computer, this relies on the user marking it and is anyway just a limited solution. Therefore, preferably the OS itself, preferably during installation, enables the administrator to specify that this is a public-use computer, and preferably this setting can be changed only for example with the original installation disk and/or with a password. Preferably when defined as a public computer, the OS itself indicates this in outgoing electronic communications such as for example emails, for example by adding this info at the socket layer, and preferably any session-related traces are automatically removed by the system for example after a short time of inactivity and/or if the user does not re-enter a password chosen by the original person that started the session, or for example such traces are not saved at all. Another possible variation is that in addition, for example the OS allows the user to send additional email messages from the same session only if he know the password entered or chosen by the user when he started the session, etc.

### BRIEF DESCRIPTION OF THE DRAWINGS

FIG. 1 is a flow chart of a preferable way the Instant Reset and Instant boot are implemented.

FIG. 2 is an illustration of a preferable example of using a separate area with separate heads on the disk or other non-volatile memory for running a hardware supported rollback feature.

FIG. 3 is an illustration of a preferable example of using a separate area with separate heads on the disk or other non-volatile memory for running one or more hardware supported FAT areas.

FIG. 4 is an example of one of the best MIDI search engine's results. FIGS. 5a-c are illustrations of a few preferable configurations that can considerably increase the speed of the hard disk, and preferably also reduce its power consumption.

### IMPORTANT CLARIFICATION AND GLOSSARY

All these drawings are just or exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Eventhough the preferred embodiments use mainly the terminology of Microsoft Windows, which is the most common and familiar operating system, the current invention can be used also in other operating systems, such as for example Linux, Macintosh, or other operating systems, even if they use different terminologies or different implementations of various features. “OS” as used throughout the patent, including the claims, means Operating System. FAT is short for File Allocation Table. However, as used throughout the patent, including the claims, FAT can mean also any other central data structure related to file allocation or management. “Scandisk” is the typical software used in Microsoft Windows to scan the disk. On normal runs it is used mainly to find inconsistencies between actual file sizes and the sizes reported in the FAT, but it can be used also for example for thorough scan to check for bad sectors, etc. As used throughout the patent, including the claims, “Scandisk” means either Scandisk, or any other similar software for checking the Integrity of the file or directory structures. “Image”, as used throughout the patent, including the claims, means a non-volatile memory Image of the OS state and preferably also loaded programs, loaded drivers, memory status, status of peripheral devices, and/or any other data that is needed for creating a sufficient snapshot of the computer's condition, so that the computer can be instantly restored to that state and operate properly by restoring or using the data from said Image. Throughout the patent, including the claims, whenever “disk” or “disks” is mentioned, it can be either a hard disk or hard disks, or any other type of fast access not-volatile memory, such as for example MRAM (Magnetic RAM), 3d Nano-memory chips, etc., and whenever heads are mentioned, it can be either read/write heads of disks, or any access mechanism for areas in other types of non-volatile memory, including when such access means do not require actual physical movement by a mechanical element.

### DETAILED DESCRIPTION OF THE PREFERRED EMBODIMENTS

All of descriptions in this and other sections are intended to be illustrative examples and not limiting.

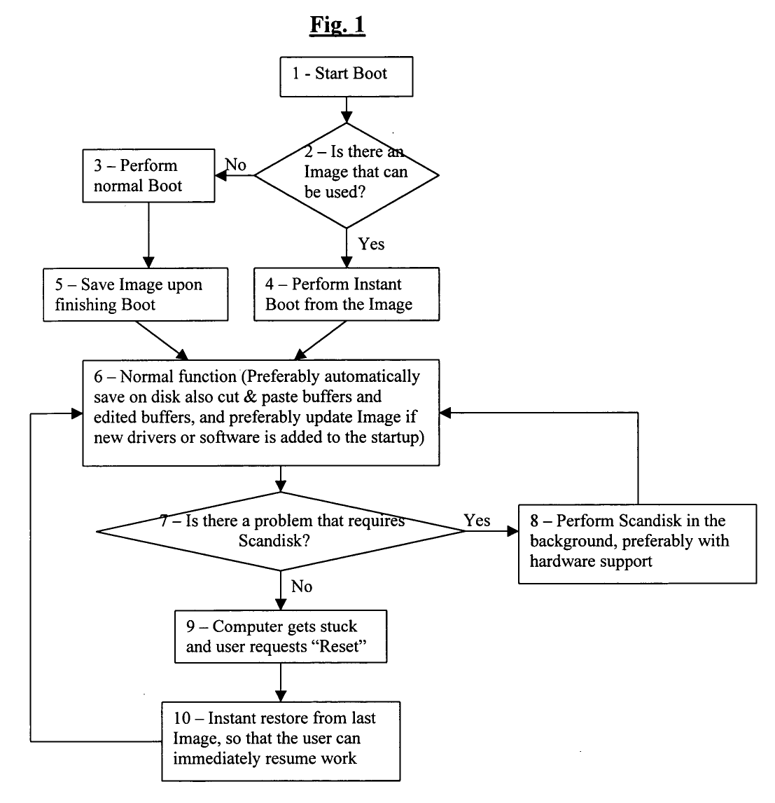

Referring to FIG. 1, I show a flow chart of a preferable way the Instant Reset and Instant boot are implemented. When a boot sequence starts (1), preferably the system checks if there is an Image that can be used for instant boot (2), and, if so, performs instant boot by loading the Image into memory (4), otherwise it performs normal boot (3) and preferably saves the OS Image upon finishing the boot. The OS Image preferably contains also all needed info about loaded drivers and/or other loaded software and preferably also for example about the state of peripheral devices, and/or any other data that is needed for creating a sufficient snapshot of the computer's condition, so that the computer can be instantly restored to that state and operate properly by restoring or using the data from said Image.

Regarding the state of the peripheral devices and resetting them, it can be handled for example in at least one of the following ways:

1. Preferably peripheral devices can be preferably instantly reset to their original status as it would exist after a normal boot, preferably for example by improving the standard protocol of drivers so that preferably each driver and device has a function for instant reset. Another possible variation is that preferably each device driver can preferably instantly query the device to see if it is in a proper state or needs to be reset.

2. Preferably the system constantly updates some area in non-volatile memory or for example some buffer or stack with the current state of the devices, so that it can be preferably instantly determined if any of the devices was involved for example in a crash or needs reset.

3. Preferably at least one or more of the devices can be kept in its current state if the user so desires instead of resetting, so that for example if the user was in the middle of an Internet connection, the user can for example remain connected without having to reset the modem or Ethernet card and reconnect. Preferably during or after the reset the system asks the user if he wants various devices to remain in their previous states or for example it is defined as default before any reset is needed and the user can change it, and during the reset the system decides what do to with such devices according to the last given instructions. As in clause 2 above, preferably this is done by automatically saving the current state of the devices in a buffer or stack.

4. If any tests or resets are still needed in one or more devices which cannot be done instantly, preferably the system can automatically decide which devices are not critical and can therefore be dealt with in the background after the user can already start working, in a way similar to postponing the disks scan, so that for example if it takes some time to check a CD device, preferably this is done after the user can already start working, since the user typically will not need to access the CD immediately. This option can be preferably used also in normal boots or instant boots or when restoring from hibernate.

5. Preferably when a Reset or an instant boot is performed, the image is first reloaded into memory including all the drivers as if they have already checked and/or reset the relevant devices, and THEN the drivers are instructed to activate the instant actual reset on the actual devices, so that the state of the device conforms to the state that the driver is supposed to represent.

6. Preferably the data on the status of any peripheral devices that can be saved in the image includes also any plug and play data for such devices and/or for any other card or relevant elements in the computer, so that preferably no plug and play automatic tests are normally needed during booting. Preferably at least during any boot or reset that is not based on turning off and turning on again the computer (cold boot) there is no need for any plug and play check for example at least of installed cards since the devices and cards that are coupled to the mainboard do not change, so preferably the system can automatically identify if it is being reset or rebooted without a cold boot, and if so, it preferably simply uses automatically the plug-and-play solution or configuration that was used last time as saved in the image. However the user might for example remove the keyboard or the mouse or a printer cable even without turning off the computer, so preferably the system checks if such devices have changed. Another possible variation is that even if a cold-boot is done, preferably the system can check instantly if the configuration of devices and/or cards and/or other relevant elements has changed or is the same as the last image, and thus avoid for example any unnecessary plug-and-play checks and instantly choose the configuration used last time, preferably as saved in the image, if the configuration has not changed.

The Image is preferably saved on the disk or other non-volatile memory with at least some preferably fast compression that allows faster transfer of the data to and from the disk. The system then preferably allows the user to start working immediately (6), and preferably immediately afterwards checks if there is a problem that requires Scandisk (7). If there is such a problem, then preferably Scandisk is performed at the background without interrupting the user's work (8), preferably with hardware support that enables it to finish even much faster, as explained in the reference to FIG. 3. Preferably the system allows a “Reset” function, which means that whenever the system gets stuck (9), preferably the user is able to press some special button or some key or keys on the keyboard in a way that causes the computer's memory to instantly Reset from the saved Image, without a need to go through a boot sequence at all (10). The special button or key is preferably sensed either by hardware or by some process which preferably runs below the Operating system and thus in not affected even when the system becomes stuck. After activating the Reset (10), preferably the system again checks if there is a problem that requires Scandisk (7), and, if so, preferably performs it again in the background as explained above (8). In addition, during normal operation, preferably any cut & paste buffers are automatically saved also on the disk or other non-volatile memory, so that they can be immediately available on the next boot or after the next Reset. Similarly, preferably any currently edited files or windows are preferably automatically saved on the disk or other non-volatile memory preferably after sufficient minimal changes have accumulated (such as for example after at least 10 new characters have been added or changed) or every short while (for example every 30 seconds), so that they can be immediately available on the next boot or after the next Reset. Although something like this exists for example in Word, it is not available in many other programs, so preferably this is ensured by the OS itself. Preferably the System allows also “undo” in case the “Reset” button or command was pressed by accident, for example by saving an additional Image of the OS and of open windows/applications before restoring the boot Image. Of course, preferably any of the above principles or variations can be used also during recovery from hibernate and/or during any boot or instant boot, such as for example the instant boot described by IBM, since in these processes too reducing any waste of time on dealing with the peripheral devices and/or any waste of time for scandisk, can allow the user to be able to start working much sooner. However, there is of course a difference between instant boot or reset and restoring from hibernate, since in the instant boot or reset the drivers have to typically be reset to the initial state after boot, whereas when restoring from hibernate they have to typically be restored to their exact state at the time of requesting the hibernate. Another possible variation is that for example when restoring from hibernate or from Reset, the system can also automatically for example continue printing from the point it stopped, for example by saving the relevant information about the process of printing and preferably being able to query the printer exactly where it stopped for example in terms of character and/or in terms of printed pages. Another possible variation is that the user can define or save for example the normal task bar itself or parts of it, so that for example upon any boot by default some Dos window will be open at a certain directory or for example Word will be open with a certain file, until changed by the user. Another possible variation is that the user can for example define group-icons, which means that a single icon can connect a number of icons so that when the user clicks on the group icon a number of applications will open automatically, with or without restoring also for example their exact arrangement of the desktop. This way for example if some users are used to work with Word on the left side of the screen and some excel table on the right side, then clicking on the group icon or saving this as boot default will automatically open the two or more applications in the correct configuration. Of course, various combinations of the above and other variations can also be used.

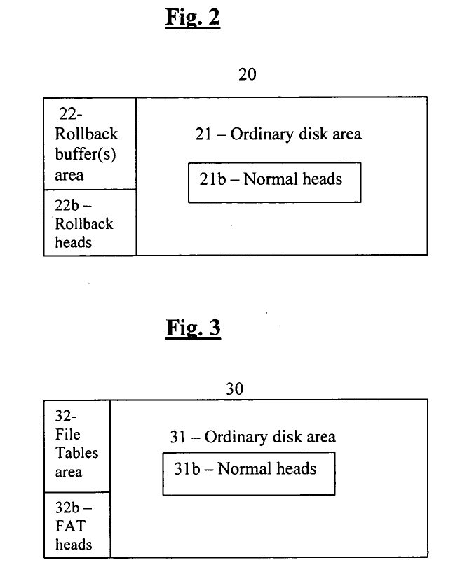

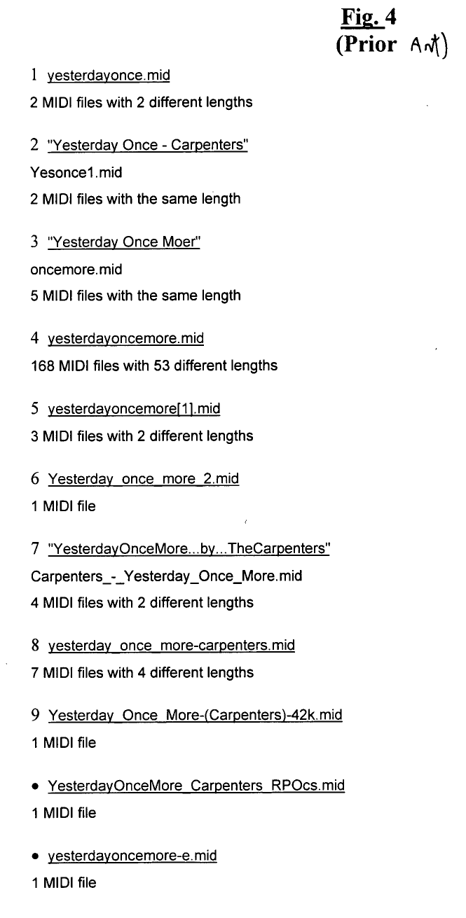

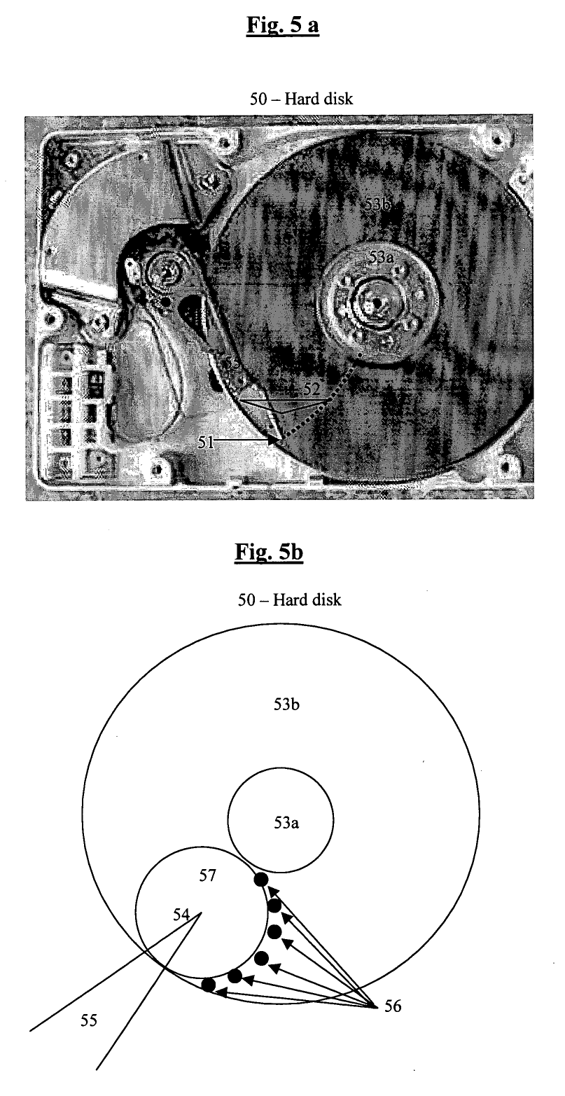

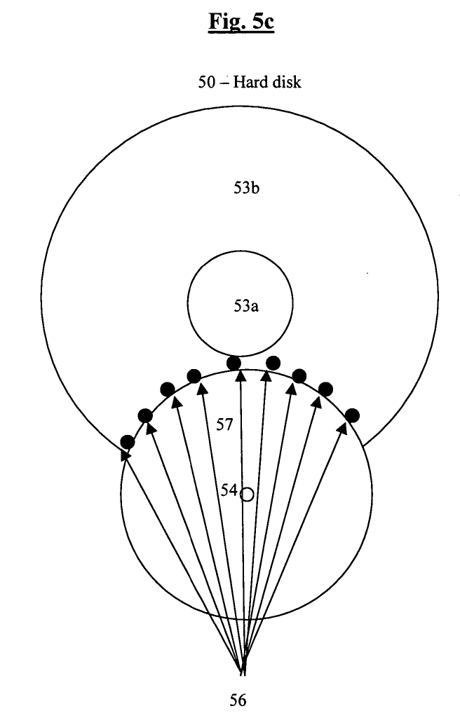

Referring to FIG. 2, I show a preferable variation where for example any changes at all that happen for example on the hard disk or other non-volatile preferably fast-access memory (20) (and possibly even on other connected writeable media, such as for example CD or DVD or other backup media) at any time are completely undo-able at least for a certain time period (or as long as there is sufficient room to save the info needed for the undo), in a way similar for example to the undo feature in a single Word document. If this is implemented also for example for other connected media, the rollback areas for them can be for example on those media and/or for example on a separate rollback area or areas or on part of the normal rollback area within the disk (or other fast non-volatile memory). This is preferably accomplished by keeping one or more rollback log, preferably backed up by appropriate hardware on the disk. The rollback can be enabled for example by creating a backup of each changed file or directory in another area at least for a certain time period or until for example the backup buffer becomes full and older backups have to be deleted automatically. Another possible variation, which saves much more space, is for example to keep a rollback log of all changes for example of directories, files, FAT areas, and/or any other data (such as for example even any low-level changes in disk tracks), so that any changes that were made on the storage media can be rolled back by simply tracing back the log of changes (this way only the changes have to be saved). Preferably this log or rollback buffer or buffers are encrypted and are highly guarded and/or are kept also in more than one place, in order to reduce the chance of its destruction by mistake or by some malicious software. This way even if the user has made a horrible mistake and the entire system has been compromised, even the worst damage can preferably still be automatically undone. Preferably the Operating System or a special Security System constantly guards itself and its files and preferably also these logs from any unauthorized changes. Another possible variation is that even commands such as for example format or re-partition or even low-level format are not able to destroy the rollback areas, so that for example at least a certain percent of the disk or other non-volatile memory is always reserved for the rollback info. Preferably the rollback logs or buffers or at least the most recent changes in them are always backed up in at least two or more separate places and/or also protected by additional encryption and/or redundancy data, so that damages can be fixed. Another possible variation is that the rollback feature is supported also by hardware, for example by a special area in the CPU or on the hard disk interface card, so that it is always available for example from a special ROM even if for example the system has been booted from another device, such as for example a diskette or CD or network drive. If it is an inherent part of the hard disk, this has the additional advantage that preferably at least part of the overhead of keeping the rollback files is run by special hardware for example on the hard disk's interface card, so that it does not burden the system or slow down disk operations. This can be done for example by keeping one or more additional read/write heads (22b) constantly near a special area of the disk (22) that is used for the rollback logs, so that accessing it for every disk change causes no additional access or seek activity of the normal read/write heads. Such an implementation can be also more secure since access to the rollback area can be limited for example on a hardware level, so that for example only an explicit command by the user entered directly by the user to the operating system through a direct command can restore changes from the rollback, so no malicious program can for example activate the command. Preferably when the user requests to restore things from the rollback, the following part of the rollback buffer is still kept, so that the user can for example also redo the “undo” by simply moving again forward on the rollback log, thus reinserting the cancelled changes. Preferably new changes to the rollback from that point on are kept on a separate part or buffer or branch, so that making additional changes from that point on will not overwrite the original “forward” part of the rollback, otherwise even changing one character after the undo can destroy the possibility of undoing the undo and returning to the original situation before the undo. (This is unlike for example the undo feature in Word, where undoing something and then adding new changes destroys the ability to go back to the situation before the undo). Preferably when going again forwards the user is shown the various branches that exist and can choose the appropriate one. Another possible variation is to add such features also for example to word processing programs, such as for example Word, so that there too the user can choose which Redo he wants if there are a number of possible branches to choose from. Another possible variation is to add to word processing programs such as for example Word also an option that if the user for example types something by mistake while “overwrite” is pressed when he actually intended to use normal insert mode (which can happen quite often) preferably the overwritten part is always saved automatically for example in some buffer and preferably the user can press some button (or for example a combination of two buttons) which instantly restores the lost text as if the mode has been “insert” instead of “overwrite” (this can be called for example “retroactively changing mode”), instead of having to use cut or copy to save the new part, than use undo, and then use paste again. Preferably the Undo in word processors such as for example Word is also improved so that,even deleting the entire contents of the file and saving it is undoable, since in the prior art for example if the user by mistake presses “\hat{ }a” (which stands for “mark all the text”) instead of “\hat{ }s” (save) and then presses backspace to delete one or more characters and then for example presses “\hat{ }s” again, the entire contents of the file can be erased and then saved like this, and then the undo does not work, so the entire file can become lost.

Since the area assigned for keeping the rollback logs is necessarily limited, preferably the rollback file or files use one or more circular buffers, so when it is full the oldest changes logged are deleted by overwriting them with the new data, and pointers to the logical beginning and end of each circular buffer are updated accordingly. If the rollback is hardware based, another possible variation is that since it can preferably work even below the operating system level, the rollback is based for example on low-level hard disk data, such as for example simply recording all changes in disk tracks or sectors, etc., so that it is independent of any file formats used by the operating system. However, this can be problematic since hard disks today typically have for example auto-moving of bad tracks to a hidden pool of “spare” tracks, so this is preferably taken into consideration. Another possible variation is that the lower level hardware is also aware of upper formats. The variations of using special hardware for example in the hard disk itself are more preferable since this is safer and faster, and can be also immune to changes done while the computer was booted from another source, unless for example a malicious software booted from another source makes on purpose so many changes that the rollback logs become overwritten. In order to prevent this, one possible variation is that for example if the hard disk senses that the boot was not made from it, it will block all further changes for example after the log file becomes too full (for example counting the cumulative amount of changes since the boot), and request the user to boot from the hard disk. Another possible variation is for example some combination between the OS and the hardware support, so that for example there are two types of low-level write commands, one with rollback enabled (for example called R Write, for Rollback enabled Write, or for example called Safe write) and one without, so that for example the operating system decides to use the safe (rollback enabled) write automatically for example when allowing changes in highly strategic directories and/or files, such as for example system files, “.doc” files and program source files. Another possible variation is that for example the Operating System or the computer's security system decide when to use the rollback enabled write and when the normal write, and for example takes care that normal files or directories are changed with the safe write, but for example swap files and other temporary files are changed with the normal write, in order to avoid burdening the rollback buffer with unimportant changes. This is less safe than the variation where every change is logged on the rollback files but has the advantage that the rollback buffer is reserved for more important changes, so they can be kept for a longer time than if also less important changes are kept on the logs. Another possible variation is that for example normal programs can also choose to use it depending on the importance of the files. However, a malicious program might for example try to create on purpose so many changes as to fill the rollback circular buffer and make it lose more real changes. Therefore, such behavior is preferably intercepted by the Operating System or a special Security system as a highly suspicious behavior. Therefore, preferably for example only the security system and/or the operating system can have access to the saving or restoring from the rollback buffer. However, if every change in the disk is automatically saved in the rollback buffer, then still a malicious program might create endless changes on purpose, so preferably it is intercepted preferably after a short time as highly suspicious behavior. Another possible variation is that for example each program or each installation directory has by default only up to a certain percent of the rollback areas allocate to it, so that it cannot take up too much of the rollback resources unless given explicit permission by the user (in this case preferably each has its own rollback circular buffer). However, a hardware based general rollback feature also can have a serious drawback that changes for example in one important file can only be undone by undoing changes in the entire disk, so for example to fix a damage that was caused to that file two months ago the user would have to undo changes of two months in the entire disk, restore the file, and then restore back the last two months on the entire disks—a very dangerous activity if anything goes wrong during the process for some reason. Therefore, a more preferable variation is that the hardware supported rollback or undo can be used also for each file separately, for example by saving a separate rollback buffer or entry for each file, or for example each log entry contains also the name and full path of the relevant file (passed to it for example as a parameter during the write operation), so that the user can choose for example if to use an “undo” on the entire disk or only on a specific file or directory or group of files or group of directories. Preferably this path info changes only when the changes start referring to a separate file, so as long as the changes are in one file, no overhead of repeating the path is needed. Another possible variation is that for example the Security system and/or the operating system use the rollback log automatically for backing up any changes in highly strategic directories and/or files without hardware support. Of course, similar principles can be used also in other types of non-volatile memory that exist or will exist in the future, so that for example if some MRAM (Magnetic RAM) or 3D memory chips are used, preferably the rollback area or areas have independent access control for fast access without slowing down the normal access the actual data areas. These rollback features can be used also independently of any other features of this invention. Of course, various combinations of the above and other variations can also be used.

Referring to FIG. 3, I show an illustration of a preferable example of using a separate area or areas (32) with separate read-write heads (32b) on the disk (or other non-volatile memory)(30) for running one or more hardware supported FAT (File Allocation Table) areas. Preferably, during or after a fast-boot or a Reset that uses the memory Image (and/or even during or after a normal boot), if the FAT of the disks needs to be checked, preferably it is done in the background, after the user can already start working, since waiting for scandisk to finish can take several minutes and can be very aggravating to most users. Preferably the Scandisk (disk canning software) or similar software is backed up by special Hard-disk hardware, in a way similar to the hardware that supports automatic disk rollback, described in the reference to FIG. 2. Preferably this is done by using hard-disks wherein a special area or areas (32) is dedicated for FAT information, and preferably independent head or heads (32b) are used for read and write in those areas. Another problem with scandisk is that for example in Windows 98 scanning the drive where the OS is installed (typically drive C:) can take a long time, since many background operations can cause the scan to restart. So preferably even if there are problematic background changes at the time of the scan, preferably the system automatically keeps track of its recent scanning activity and thus preferably can jump back and forth temporarily if needed but does not need to restart the scan after such changes. This has the further advantage that also with normal disk activity any reading or writing of files can become faster even if they are fragmented, since less movements of the heads are needed to access the FAT area each time some jump is needed. Since each disk can have more than one partition, preferably the FAT areas of all partitions are kept in the same special area or areas (32). Preferably these areas are also guarded better in terms of security, so that for example any write-access to them is monitored more closely. Of course, various combinations of the above and other variations can also be used, such as for example various combinations of features of FIG. 2 with features FIG. 3, so that for example both separate FAT area or areas with special access and other separate Rollback area or areas with special access are used, or for example the same special area or areas are used for both the rollback and the FAT. Another possible variation is that the disks or other non-volatile memory contain also one or more processors that can themselves conduct the comparison between the files and the FAT, so that it can be done in the background even with little or no consuming of CPU resources from the computer itself. Of course, similar principles can be used also in other types of non-volatile memory that exist or will exist in the future, so that for example if some MRAM (Magnetic RAM) or 3D memory chips are used, preferably the FAT area or areas have independent access such as for example independent communication channel and/or processor for fast access without slowing down the normal access the actual data areas. Similar principles can be used for example to speed up writing and/or reading for example on CDs, DVDs, and writeable or rewriteable CDs or DVDs (for example by using two or more separate laser beams—one or more for the normal data and one or more for a FAT or similar area), since jumping back and forth between the FAT area and the normal data areas is one of the things that most slow down such devices for example when copying a large number of files to them. Of course, these features can be used also independently of any other features of this invention. Of course, various combinations of the above and other variations can also be used.

Referring to FIGS. 5a-c I show illustrations of a few preferable configurations that can considerably increase the speed of the hard disk and/or reduce its power consumption. FIG. 5 a shows a hard disk (50) with one of the rotating plates (53a) and its central hub (53b). As can be seen, the arm (55) that contains the read-write head (51) rotates part of a circle (along the dotted arc) in order to reach any desired track in the disk. Typically there are multiple such plates, and the arms go also between them, so that typically each arm can read/write the relevant sides of both the plate that is above it and the plate that is below it. By adding for example a preferably small fork with an additional head (52) the arm now only needs to move half of the way in order to reach any desired track, so that head 52 can take care of all the inner tracks and head 51 can take care of all the outer tracks. Since the arm itself is much more massive than the heads, this addition should not cause a significant addition to the total mass of the arm. An additional improvement is that preferably both heads can now read and write at the same time, thus doubling also the speed of data transfer. Of course, this is just an example and for example more than one additional head can be added in a similar way to each arm. (Like head 51, the added head 52 is preferably actually two heads, one for reading the appropriate side of the plate that is below it and one for reading the appropriate side of the plate that is above it). FIG. 5b shows a similar solution, except that the arm (55) is now stationary, preferably reaching the middle track, and preferably at its tip (54) is connected an additional preferably thin rotating plate (57) which contains preferably multiple read-write heads (56). This plate is preferably rotated by a flat step engine or voice coil, and its mass is now preferably much smaller and also the amount of rotation needed is much smaller (for example only ⅙ or the original arc, if there are now for example 6, preferably double sided, read/write heads). And like in FIG. 5a, preferably each head covers only its own range of tracks and all heads can preferably work simultaneously, so that preferably when the data is written it is also spread between the tracks accordingly, thus increasing the read/write transfer rate by a factor of 6, in this example. (Of course 6 heads is just an example and any other convenient number can also be used). The smaller mass of plate 57 and the much smaller amount of rotation that is needed can thus also reduce considerably the power consumption and thus can be especially fit for example also for hard disks in laptops (mobile computers). The configuration of FIG. 5c is very similar to that of FIG. 5b, except that the hub (54) of plate 57 is now outside the area of the disk's rotating plates (53b), thus allowing more room for the mechanics of the engine that rotates plate 57, however this takes up more room altogether. Of course these configurations are preferably used for all the layers of the disk, so that preferably multiple such side plates replace the normal arms. Another possible variation is that, instead of jumping into a certain position each time, plate 57 for example constantly rotates (thus saving the need for fast acceleration and stopping for each jump), and the rotations of plate 57 and of the disk's plates (53b) are specially correlated: However this solution is much more problematic and requires unusual read/write patterns. Of course, various combinations of the above and other variations can also be used. Of course, like other features of this invention, these features can be used also independently of any other features of this invention.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A System for improving the efficiency, comfort, and/or reliability in Operating Systems, comprising at least one of:
a. A mechanism for instant Resetting of the OS into the normal state it would be in after a successful boot, without the need to boot at all.
b. A mechanism for automatically scanning the nonvolatile memory in the background without significantly slowing down the computer after a boot or a Reset while allowing the user to immediately start working after the boot or Reset.
c. A mechanism for preventing other programs from snatching the focus while the user is typing.
d. A mechanism for allowing the user to install a new Operating System in another partition or directory with copying the desktop of the original system to the new system and automatically converting as many programs as possible to work in the new system.
e. An automatic rollback feature that is adapted to enable undoing any changes on the non-volatile memory.
f. Independent access mechanisms to at least one rollback area, so as not to adversely affect speed of access to the normal data areas.
g. Independent access mechanisms to at least one FAT area, so as not to adversely affect speed of access to the normal data areas.

2. The system of claim 1 wherein at least one of the following features exists:
a. An Image of the state of the OS is saved immediately after a successful boot on non-volatile memory and is automatically updated when new drivers and/or software that changes the state after a boot is added.
b. More than one image of the state of the OS is saved immediately after a successful boot on non-volatile memory, so that the system can go back also to the previous Image when needed.

3. (Canceled).

4. The system of claim 1 wherein whenever the system gets stuck and/or the user wants to clear the computer's memory and go back to a state like after a normal boot the user can cause the computer's memory to instantly Reset from the saved Image, without a need to go through a boot sequence at all, and for activating said Reset, the user's request is sensed by at least one of: Hardware, and Some process that runs below the Operating system and thus in not affected even when the system becomes stuck.

5. (Canceled).

6. The system of claim 2 wherein at least one of the following features exist:
a. Any cut & paste buffers are automatically saved also on the disk or other non-volatile memory, so that they can be immediately available on the next boot or after the next Reset.
b. Any currently edited files or windows are automatically saved on the disk or other non-volatile memory after sufficient minimal changes have accumulated, so that they can be immediately available on the next boot or after the next Reset.
c. After a fast-boot or Reset that uses the memory Image, and/or even during or after a normal boot, if the FAT of the disks or other non-volatile memory needs to be checked, it is done in the background and without significantly slowing down the disk or the CPU, after the user can already start working.
d. The disk or other non-volatile memory scanning software is backed up by hardware, by using special area or areas dedicated for FAT information, and independent access means are used for read and write in those areas.
e. Any reading or writing of files is done with the aid of using separate access means to access the FAT area or areas.

7. The system of claim 1 wherein when the user is in the middle of typing something, the focus can be automatically snatched away by another program only under at least one of the following limitations:
a. The change of focus can occur only after the user has stopped typing for a certain minimal period.
b. The focus can be snatch by other programs only in case of emergency.
c. The focus can be snatched by other programs only in case of emergency, and such emergency can be decided only by at least one of: The OS, the security system of the computer, the firewall, and any other software which has been given explicit permission by the user to have such rights.
d. Programs are not allowed to snatch away the focus while the user is in the middle of typing something, but in case of emergency, instead of snatching away the focus, important messages can be displayed by flashing a message and/or other conspicuous visual means and/or by audible sound, so that the user's attention can be immediately grabbed, without automatically disturbing his typing efforts.
e. If the focus is snatched while the user was typing, his keystrokes continue to be kept in a buffer, so that when the user notices that the focus has changed and goes back to the original window where he was typing, the keys that he typed while the focus has changed are again available.

8. The system of claim 1 wherein when installing a new OS in a new directory or partition, the new system copies the desktop configuration and links from the old system into the desktop of the new system, and at least one of the following is done in order to enable the links in the new desktop to work in the new OS:
a. During installation of the new system, the system tries to automatically convert components that are different between the two systems to work on the new system.
b. During installation of the new system, the system tries to locate the original files which were used for the installation and then tries to reinstall automatically the correct drivers or components that are needed for the new system.
c. Each Windows system keeps information about the path and name of the original file from which it was installed in at least one of: The registry, and At least one directory where the installed program or component or drivers resides.
d. If the system does not success in converting the relevant links to work on the new system, then the system does at least one of the following: 1. The system marks the relevant links on the new desktop as non-operational and encourages the user to look for other versions of those programs that are fitted to work on the new system, and 2. The system allows the link to activate the version that runs under the old system or creates another copy of it, and uses emulation of the old system when needed in order to let it run
e. A new protocol for installing programs is implemented so that each installation of new software installs both the appropriate drivers or components and at least one set of alternate drivers or components for additional OS, and each time the program is loaded into memory the appropriate set of drivers or components is automatically chosen by the OS, and the parts of the installation that require updating registries and/or installing various components in system directories are suspended and are executed automatically when the new OS is activated for the first time.

9. (Canceled).

10. The system of claim 1 wherein changes that happen on at least one of the hard disk, other non-volatile fast access memory, and other connected writeble media—are completely undo-able at least for a certain time period or as long as there is sufficient room for saving the info needed for the undo, by using at least one hardware supported rollback area, and the undo feature is accomplished by at least one of the following features:
a. At least one rollback buffer is kept and is encrypted and is highly guarded and/or is kept also in more than one place.
b. Even commands such as format or re-partition or even low-level format are not able to destroy the at least one rollback area, so at least a certain percent of the non-volatile memory is always reserved for the rollback info.
c. The rollback logs or at least the most recent changes in them are always backed up in at least two or more separate places and/or also protected by additional encryption and/or redundancy data, so that damages can be fixed.
d. Only an explicit command by the user entered directly by the user to the operating system through a direct command can restore changes from the rollback, so no malicious program can activate the command.
e. When the user requests to restore things from the rollback, the log is still kept, so that the user can also redo the “undo” by simply moving again forward on the rollback log, thus reinserting the cancelled changes, and new changes to the rollback from that point on are kept on a separate part or buffer or branch, so that making additional changes from that point on will not overwrite the original “forward” part of the rollback
f. When going again forwards the user is shown the various branches that exist and can choose the appropriate one.
g. The rollback file or files use one or more circular buffers, so when it is fill the oldest changes logged are deleted by overwriting them with the new data, and pointers to the logical beginning and end of each circular buffer are updated accordingly.
h. If the hard disk senses that the boot was not made from it, it will block all further changes after the log file becomes too full, and request the user to boot from the hard disk.
i. There are two types of low-level write commands, one with rollback enabled and one without, so that the rollback enabled write is used for important data and the normal write is used for at least one of unimportant data, temporary file areas and swap file areas.
j. At least one of the operating system and the computer's security system decide when to use the rollback enabled write and when to use the normal write.
k. If a malicious program tries to create suspicious massive changes on purpose in order to fill the rollback buffer, it is intercepted as highly suspicious behavior.

11. The system of claim 10 wherein the hardware supported undo can be used also for each file separately, by at least one of:
a. Saving a separate rollback buffer or entry for each file.
b. Each log entry contains also the name and full path of the relevant file, so that the user can choose if to use an “undo” on the entire disk or only on a specific file or directory or group of files or group of directories.
c. Said path info changes only when the changes start referring to a separate file, so as long as the changes are in one file, no overhead of repeating the path is needed.

12. (Canceled).

13. The system of claim 1 wherein at least one separate FAT area on the non-volatile memory is used with independent access that does not slow down access to normal data areas and at least one of the following features exists:
a. Said non-volatile memory is at least one hard disk and said independent access is based on at least one independent read/write head for accessing the at least one separate FAT area.
b. Said non-volatile memory is Magnetic RAM and said independent access is based on at least one of independent communication channel, and independent processor.
c. Said non-volatile memory is at least one of writeable or rewriteable CDs or DVDs and at least two separate laser beams are used—at least one for the normal data and at least one for the at least one special FAT area.

14. The system of claim 1 wherein at least one of separate FAT area access and separate Rollback area access are enabled, by at least one of:
a. Using a separate access to the at least one separate rollback area and a different separate access to the at least one separate FAT area.
b. Using the same at least one special area with special access for both the rollback and the FAT.
c. The disks or other non-volatile memory contain also one or more processors that can themselves conduct the comparison between the files and the FAT, so that it can be done in the background even with little or no consuming of CPU resources from the computer itself.

15-28. (Canceled).

29. The system of claim 1 wherein at least one of the following features exists:
a. Any changes in the entire hard disk or other types of fast mass storage non-volatile memory after or during installation of new software, are completely undo-able at least for a certain time period by using a rollback buffer.
b. Each program or each installation directory has by default only up to a certain percent of the rollback areas allocate to it, so that it cannot take up too much of the rollback resources unless given explicit permission by the user.
c. Any changes in the entire hard disk or other types of fast mass storage non-volatile memory after or during installation of new software, are completely undo-able at least for a certain time period by using a rollback buffer.
d. The “copy” command is extended so that multiple destinations can be used, so that for example copy “bet*.doc 1: n:” will copy all the relevant files to both destination drives/directories.
e. The system runs a minimal scandisk in advance at most only on the area where the image itself is stored or does that only if there is some CRC problem when trying to get the image, since only that area might have to be scanned before the boot or Reset if there is a problem.

30-32. (Canceled).

33. The system of claim I wherein at least one of the following features exist regarding priority of processes:
a. The user can easily define the desired priority level for a processes by clicking on the place where the priority is indicated at or near the taskbar and/or on the window of the process, by at least one of: Defining percentages, Increasing or decreasing some default values in discrete steps, and Using more general definitions, such as “Very high, high, medium, low, very low”.
b. The OS indicates to the user clearly the priority level of each process, at or near the task bar and/or at the top line of the window of the process, by at least one of: Colors, numeric values, textual values, and appropriate icons, the level of priority that has been given to each process, by indicating it near or on each square in the taskbar that shows active processes or elsewhere.
c. The OS remembers the priorities given by the user to various processes and uses these defaults or at least takes them into consideration for assigning automatically the priorities the next time the user does similar things or activates the same processes, unless the user again changes the priorities.
d. The taskbar can show automatically how much percent of CPU is being used on average by each open process.
e. The priority of background and/or foreground processes is automatically dynamically increased according to the type of the work the user is doing in the foreground window.
f. If the user changes the priority by clicking on something on the process window itself, the user is asked if to keep a high priority for this process also when it is in background, or this is the assumed default and the user has to indicate if he wishes otherwise.
g. If the user changes the priority by clicking at or near the taskbar then the system assumes automatically that this refers to the process when running in background.

34. The system of claim 1 wherein at least one of the following features exist regarding resetting the state of the peripheral devices during Reset or during an instant boot:
a. Peripheral devices can be instantly reset to their original status as it would exist after a normal boot by improving the standard protocol of drivers so that they have a function for instant reset.
b. Device drivers can instantly query the device to see if it is in a proper state or needs to be reset.
c. The system constantly updates some area in non-volatile memory or some buffer or stack with the current state of the devices, so that it can be instantly determined if any of the devices was involved in a crash or needs reset.
d. At least one or more of the devices can be kept in its current state if the user so desires instead of resetting.
e. During or after the reset the system asks the user if he wants various devices to remain in their previous states, or it is defined as default before any reset is needed and the user can change it.
f. If any tests or resets are still needed in one or more devices which cannot be done instantly, the system can automatically decide which devices are not critical and can therefore be dealt with in the background after the user can already start working, in a way similar to postponing the disks scan.
g. When a restore or an instant boot is performed, the image is first reloaded into memory including all the drivers as if they have already checked and/or reset the relevant devices, and then the drivers are instructed to activate the instant actual reset on the actual devices, so that the state of the device conforms to the state that the driver is supposed to represent.
h. The data on the status of any peripheral devices that can be saved in the image includes also any plug and play data for such devices and/or for any other card or relevant elements in the computer, so that no plug and play automatic tests are normally needed during booting.
i. At least during any boot or reset that is not based on turning off and turning on again the computer (cold boot) the system can automatically identify if it is being reset or rebooted without a cold boot, and if so, it simply uses automatically the plug-and-play solution or configuration that was used last time as saved in the image.
j. Even if a cold-boot is done, the system can check instantly if the configuration of devices and/or cards and/or other relevant elements has changed or is the same as the last image, and thus avoid any unnecessary plug-and-play checks and instantly choose the configuration used last time.

35. The system of claim 1 wherein at least one of the following features exist:
a. The user can define or save the normal task bar itself or parts of it, so that upon any boot it is available again by default.
b. The user can for define group-icons, which means that a single icon can connect a number of icons so that when the user clicks the group icon a number of applications will open automatically, with or without restoring also their exact arrangement of the desktop.
c. Clicking with the mouse or any part of the desktop will immediately bring the desktop filly into the foreground so that other windows that cover parts of it move down to the task bar.

36. The system of claim I wherein in at least one word processor at least one of the following features exist:
a. New changes after an undo are kept on a separate part or buffer or branch, so that making additional changes from that point on will not overwrite the original “forward” part of in case the user wants to redo it again, and when going again forwards the user is shown the various branches that exist and can choose the appropriate one.
b. If the user types something by mistake while “overwrite” is pressed when he actually intended to use normal insert mode, the overwritten part is always saved automatically in some buffer and the user can press a button or buttons which instantly restore the lost text as if the mode has been “insert” instead of “overwrite”.
c. The Undo in word processors is also improved so that even deleting the entire contents of the file and saving it is undoable.
d. There is a file-compare feature that can show exactly the textual differences between two or more files while disregarding irrelevant data such as line breaks and fonts.

37-42. (Canceled).

43. An Operating System wherein in at least one word processor at least one of the following features exists:
a. Two files can be merged into a single file with highlighted changes just as if one of the files was created out of the other while keeping the “highlight changes” option to On.
b. Cut & paste of one file over another file and/or cut & paste of any section over another section when “highlight changes” is set to ON automatically generates the highlighted changes between the two sections as if they were made by actually changing one to the other.
c. The word processing program behaves consistently with cut & paste where Internet pages are involved, so that if the links are to local images then they are automatically inserted into the document file itself, and if they are based on links to the actual Internet then they are included internally in the document and/or are saved as links, and/or the user has a choice about this.
d. The word processing program remembers automatically in the “Open file” dialogue box and/or in the “Save” dialogue box if the user typed last time a filename (or path) in English or in another language and leaves this as the default for the next time.
e. The user can undo the last changes even after closing and reopening a file, and this enabled by saving the undo data in the file itself, or by saving it in another local file, so that the original file only contains a link to the associated local undo file.
f. The word processor program allows the user also options of searching and/or substituting based on style and/or shape and/or size instead of just character strings.
g. Combining two paragraphs or deleting the empty line between them does not change the fonts or style of the first paragraph, and fonts and/or style in the 2^{nd} paragraph change after connecting it with the 1^{st} paragraph only if the user allows this by default or requests this specifically.
h. If the user wants to mark large areas with the mouse, while the mouse key is still pressed, the user can use other location commands instead of waiting for the pages to scroll, and then the entire area till the next location becomes marked.
i. The user can choose a specific font color and/or font attribute, which is kept automatically until changed again, so that this text appears wherever the user adds it to previous text, regardless of the color or other attributes of the previous text where the new text is inserted.
i. In a word processor URL links are automatically and dynamically broken and restored between the lines as the paragraph chances, according to slashes and/or underlines and/or dots and/or other special characters, and when the user presses the link, it is treated as one consecutive link regardless of this automatically changing break between the lines.

44. A System for improving the efficiency, comfort, and/or reliability in Operating Systems, comprising at least one of:
a. A mechanism for allowing the user to define at least one User which the system will enter by default and without a password if the user does not request to enter a particular User after a certain time.
b. A mechanism for allowing the user to define at least one User which the system will enter by default and without a password if the user does not request to enter a particular User after a certain time, and wherein if the system enters the User without password, it enters a limited mode where it takes no commands from the keyboard or mouse or has other limitations until the user enters some password.
c. A mechanism by which backup software can automatically rename the older versions of the same back-up-files on the backup media with some automatically sequenced extension, so that the user can automatically keep and track also older versions this way.
d. A mechanism for automatic backup of important files to the default backup directory and/or drive, so that each relevant file that has been created or changed and has not been updated for more than a certain time period, and/or after a certain threshold amount of change even if less time has elapsed, is automatically backed-up on the default back-up media.
e. A mechanism wherein during each boot the system keeps a log of all successful steps in the boot, and so even if a certain step causes a crash so that the system can't even report the problem, in the next boot the system knows by the incomplete step in the log exactly where it crashed the last time and can automatically complete the boot this time without the problematic step and can report to the user exactly what the problem was and/or can automatically remove the problem and/or offer the user to chose among a few possible corrections to the problem.
f. A mechanism for allowing the user to execute files in DOS mode also by clicking on or near their name instead of having to type it.

45. The system of claim 43 wherein at least one of the following features exists:
a. If at least one of two compared files already contains marked changes, a different indication is used between the old changes and the new changes generated by the comparison.
b. If at least one of two compared files already contains marked changes, a different indication is used between the old changes and the new changes generated by the comparison, and said different indication is by at least one of: Using additional colors, using different special icons and/or marks near the old changes and/or near the new changes, using different special squares and/or other frames around the old and/or the new changes, using special fonts and/or other font characteristics, and marking the old changes are automatically by more faded or less lit colors.
c. When making file comparisons the system uses various heuristics in order to extract from the document important information about its structure, based on at least one of identifying headlines and identifying other different characteristics of various sections, and uses these cues to try to avoid erroneously mixing between sections.
d. When comparing files, if the user sees that one or more parts of the documents have not been properly merged, the user can mark the problematic section and tell the system to try again to merge more properly the problematic section or sections.
e. The system allows to compare also more than two files in each step, and so in the merged file of more than files changes that come from different files are marked in different colors or marked differentially by other methods.

46. (Canceled).

47. (Canceled).

48. The system of claim 1 wherein in statistical packages when correlations or other types of output are displayed for a large number of variables, at least one of the following features exists:
a. The user can instruct the system to automatically mark for him/her the most significant correlations and/or other result types.
b. The user can instruct the system to automatically mark for him/her the most significant results, and the criteria for which correlations and/or other result types are sufficiently significant can be at least one of: Some default criteria defined by the user and/or automatically by the system, such as for example only correlations above a certain value and/or significance above a certain value, or the cutting points automatically and/or by user definition can change dynamically according to the results, and/or the best results are marked or displayed according to a certain top percentage.
c. The user can mark one or more sections of the results so that these automatic marking or statistics will be run only on parts of the results.
d. The system can report various meta-statistics, wherein said meta-statistics include at least one of: what percent of the correlations are beyond certain cutpoints, what is the significance of these meta-results, what number of results was marked out of what total, what percent it is, and what is the chance of having such a meta-results by chance.
e. The system use more than one type of mark, so that 2 or more levels of significance are marked differently, more conspicuously and/or with different colors.
f. The system can automatically sort the results according to their value and/or importance and or significance.
g. Instead of marking correlations or other results, only the relevant results that fit the criteria and/or would have been marked are printed, thus saving paper and time.
h. Instead of marking correlations or other results, only the relevant results that fit the criteria and/or would have been marked are printed, thus saving paper and time, and this is accompanied by meta-statistics that refer also to the non-printed results.
i. The system can automatically and/or by user request generate also various graphs for visually displaying said meta-statistics.
j. For the marking and/or sorting and/or meta-statistics the system can automatically ignore at least one of: All the correlations of variables with themselves, and any other correlations that the user marked as less meaningful and/or that the system can automatically determine as being less meaningful.

49. The system of claim 48 wherein at least one of the following features exists:
a. These automatic markings and/or meta-statistics can be applied for each statistical procedure or command separately or for to the entire set of procedures or commands on the same Run.
b. The system can automatically run the tests also on automatic randomly divided sub-samples, and the number and/or size of the sub-samples is determined automatically according to various rules and/or according to various parameters of the actual data.
c. The correlations (or other statistics results) can also be marked differently and/or displayed in a different section if they are more stable across random sub-sample tests, and/or their sorting can take these stability results also into account.
d. For defining automatic random sub-samples the user may choose among a number of pre-defined sets of rules or define his own rules, and these definitions can then be applied automatically to any of the normal statistical procedures that are used for that run.

50. The system of claim 1 wherein at least one of the following features exists in Internet browsers and/or other programs that access the Internet:
a. The browser can request from the server also to retrieve just a part of an Internet page, as defined by a certain line and/or the value near certain words or areas or fields in the page, and this is supported by the server being able to search also normal web pages and send back just the desired data in response to such a request.
b. The user can mark a group of links in the history list and/or in the bookmarks list of the browser, and/or in any web page that contains links, so that after the user marks the desired group or groups of links, the browser can automatically open multiple windows so that each window accesses automatically one of the marked links.

51. The system of claim 1 wherein the speed of the hard disk is increased and/or its power consumption is reduced, by at least one of the following features:
a. Adding at least one fork with an additional head to the rotating arms that contain the read/write heads, so the each arm now only needs to move part of the way in order to reach any desired track.
b. Adding at least one fork with an additional head to the rotating arms that contain the read/write heads, so each arm now only needs to move part of the way in order to reach any desired track, and both heads can read/write data simultaneously, thus increasing also the data transfer rate.
c. Using at least one stationary arm that reaches more or less the middle track, and carries an additional rotating plate which contains multiple read-write heads, so that considerably less movement is needed to reach any track.
d. Using at least one stationary arm that reaches more or less the middle track, and carries an additional rotating plate which contains multiple read-write heads, so that considerably less movement is needed to reach any track, and the heads can read/write data simultaneously, thus increasing also the data transfer rate.
e. Using at least one rotating plate with a hub outside the area of the disk's rotating plates, wherein said plate contains multiple read-write heads, so that considerably less movement is needed to reach any track.
f. Using at least one rotating plate with a hub outside the area of the disk's rotating plates, wherein the plate contains multiple read-write heads, so that considerably less movement is needed to reach any track, and the heads can read/write data simultaneously, thus increasing also the data transfer rate.
